(19) United States
(12) Patent Application Publication
(10) Pub. No.: US 2019/0095842 A1
(43) Pub. Date: Mar. 28, 2019

(54) HIGH-INPUT AND HIGH-DIMENSIONALITY DATA DECISIONING METHODS AND SYSTEMS

(71) Applicant: SurfaceOwl, Inc., San Mateo, CA (US)

(72) Inventor: Christopher Brousseau, San Mateo, CA (US)

(21) Appl. No.: 16/139,911

(22) Filed: Sep. 24, 2018

Related U.S. Application Data
(60) Provisional application No. 62/563,002, filed on Sep. 25, 2017.

(51) Int. Cl. G06Q 10/06; G06N 7/08; G06F 3/0482; G06F 3/0486

(52) U.S. Cl. CPC G06Q 10/06393; G06F 3/0486; G06F 3/0482; G06N 7/08

(57) ABSTRACT

A system is provided for manufacturing physical goods. The system includes an input device configured to generate or receive input data, the input data describing parameters of one or more production facilities. The system includes a computer processor configured to map the input data onto a graph, wherein each vertex of the graph comprises one or more solution elements. The computer processor is configured to apply one or more graph pruning algorithms to the graph. The computer processer is configured to determine one or more of the graph vertices as candidate solutions. The system includes a display device configured to display a graphical representation of the candidate solutions. The system includes at least one production machine configured to received configuration parameters according to a selected one of the candidate solutions. The configuration parameters are effective to control the operation of the production machine to manufacture a physical good.

### CROSS-REFERENCE TO RELATED APPLICATIONS

This patent document claims priority to and benefits of U.S. Provisional Patent Application No. 62/563,002 entitled “HIGH-INPUT AND HIGH-DIMENSIONALITY DATA DECISIONING SYSTEM” filed on Sep. 25, 2017. The entire content of the aforementioned patent application is incorporated by reference as part of the disclosure of this patent document.

### TECHNICAL FIELD

This application relates to systems, processes, and articles of manufacture for artificial intelligence as it relates to decisioning on high-input and high-dimensionality data.

### BACKGROUND

As computing technology has advanced, computers have been able to solve many complex computing problems. However, even the most modern computing has limitations. For example, a problem classified as NP, NP-Complete, or NP-Hard is a problem that cannot be solved in polynomial time. And the lack of a polynomial time solution is significant. Essentially, as the input size grows from a small number of inputs to a large number of inputs, these problems essentially become unsolvable, even by the most powerful of modern computers. These classes ultimately include many different problems, such as finding the shortest route between all cities on a map.

But even for the class of problems that have polynomial time solutions, those classified as P, difficulties in computing a solution can arise. For example, in a limited hardware environment, even a problem with a polynomial time solution and a small quantity of inputs can be time-consuming to solve. As another example, even with more hardware resources, a problem with a polynomial time solution and a large quantity of inputs can be time-consuming to solve. If the inputs are high-dimensional, i.e., the values for each input are spread across a large number of different values, then the problem is worsened. Thus, a solution to solving high complexity problems or low complexity problems with high quantity of input and high-dimensionality of inputs is needed.

### SUMMARY

According to some aspects, a system and method for computing candidate solutions is provided. The system and method includes an input device configured to receive a high quantity of high-dimensionality data as input, or discover a high quantity of high-dimensionality data as input, or compute a high quantity of high-dimensionality data as input. The system further includes a computer processor configured to map the input data onto a graph. Each vertex of the graph comprises one or more solution elements, otherwise known as dimensions. The computer processor is further configured to apply one or more graph pruning algorithms to the graph. The computer processer is further configured to determine one or more of the graph vertices as candidate solutions. The system further includes a display device configured to display a graphical representation of the candidate solutions, wherein the graphical representation includes a spatial representation of the candidate solutions organized by measurement criteria.

### BRIEF DESCRIPTION OF THE DRAWINGS

FIG. 1 is a conventional display output.

FIG. 2 is a visual map according to some embodiments.

FIG. 3 is an interface according to some embodiments.

FIG. 4 is an interface according to some embodiments.

FIG. 5 is an interface according to some embodiments.

FIG. 6 is an interface according to some embodiments.

FIG. 7 is an interface according to some embodiments.

FIG. 8 is an interface according to some embodiments.

FIG. 9 is an interface according to some embodiments.

FIG. 10 illustrates an environment according to some embodiments.

FIG. 11 illustrates a user device according to some embodiments.

FIG. 12 illustrates an input processing and decision support engine according to some embodiments.

FIG. 13 illustrates a process for working with baseline/inputs according to some embodiments.

FIG. 14 illustrates a process for reviewing performance benchmarks according to some embodiments.

FIG. 15 illustrates a process for developing/exploring decisions according to some embodiments.

FIG. 16 illustrates a process for generating solutions and processing inputs.

FIG. 17 illustrates a Dynamic Interactive Visualization Explorer (DIVE) engine according to some embodiments.

FIG. 18 illustrates a process for viewing saved decisions according to some embodiments.

FIG. 19 illustrates an exemplary use case for deploying software across multiple cloud computing services according to some embodiments.

FIG. 20 illustrates an exemplary use case for manufacturing across multiple production facilities according to some embodiments.

FIG. 21 illustrates an example of the set intersection operation.

FIG. 22 illustrates an example of the set intersection operations for three sets.

FIGS. 23A-23C illustrate examples of various intersecting sets.

### DETAILED DESCRIPTION

Existing systems do not solve this problem. Existing systems tend to either focus on advanced artificial intelligence and machine learning algorithms for image recognition or signal processing. Other existing systems are focused on automated benchmarking of communications network performance, identifying low level gaps or shortfalls in performance of a system—but not solutions; or optimization of decisions by the computer alone (within a specific function, and requiring pairwise comparison). Some existing systems have limited interactive visual tools that are limited in various ways. Some existing systems have uses by specific business entities.

Existing systems suffer from at least the following problems. Existing systems identify problems, or specific elements of a process that may contribute to one or more problems in a decision space, but not solutions to those problems. Existing systems require optimization, in one example pair wise comparison of all decisions and computation of a ranked or weighted score. These systems are optimization focused, and do not allow human-in-the-loop decisions; or provide only a single solution, or relatively few solutions to a problem. Existing systems do not have interactive visualizations—automated generation of preconfigured visualizations that are not applied to generation of outcomes or pruning of a graph. These are based on any specific input, but rather applied to generic “static data and data streams”. Existing systems have interactive multidimensional visualizations that require ranking of the items, or create ranking of the items, or are presented as a series of different visualizations. Existing systems require prior knowledge of specific goals or objectives to enable optimization to be computable. Existing systems provide various narrow technical limitations relating to architecture or application of the system. Existing systems apply to only one element of the system and method proposed in this disclosure.

A system and method embodied on one or more computers, that simplifies complex decisions by mirroring human intuition that is both rare and expensive. The system and method merges artificial intelligence (AI) and business insights into a new visual decision engine that keeps humans in the loop, and augments human insight with AI—commonly known as “augmented intelligence”. This visual decision engine allows people to discover new options and make decisions in many decision spaces where the landscape of potential choices is large, complex and multidimensional.

To create and discover decision options or to ingest and discover insights about existing options relating to decisions in areas which are very complex, and not possible to address without the support of a system and method.

There are two primary use cases—generation and analysis (which includes the activities of decision option generation, pruning, selection); and portfolio analysis (which includes the activity of a user input of potential decisions followed by, pruning and then selection).

In various embodiments, the system may have any of a variety of new aspects. For example, the system may have generation of a graph of solutions, at a scale that is not possible with current tools and tactics, that exist for a set of conditions, coupled with automated pruning of the graph of solutions with an output sensitive algorithm. As another example, the system may have import of a pre-existing set of solutions, or a pre-existing portfolio of items, for population into a graph. As another example, the system may have display and pruning of a graph, whether generated or imported, in a visual decision engine. As another example, the system may have saving and exporting of options and decisions and decision criteria from the graph.

Various other benefits are provided. Delivers outcome focused decisions based on public and private values of the user, and enables the user to discover private preferences and tradeoff preferences that may or may not have been anticipated prior to use of the system and method. Generates a very large number of choices instead of only a few choices. This solves the problem of users not planning, because they don't see a choice they prefer. More choices increase the probability users will find one or more choices they prefer and increases the probability they will act. Generates new insights based on crowdsourcing of data, and generation of choices, and applies those insights automatically to future solutions created by users. Avoids NP-Complete requirements for large generated solution space. Avoids requirement of having prior knowledge of specific goals or objectives to enable optimization, or to be computable. Keeps humans-in-the-loop for decisions. Existing systems often seeks “optimal” solutions, which is impossible in many decision spaces for various widely known reasons. Presents a simple, interactive visual map or large, complex/multidimensional space in—so that users can easily find the preferred decisions. Enables interaction with the visual map, so that users can modify controls that result in changes to the visual map that help make the decision.

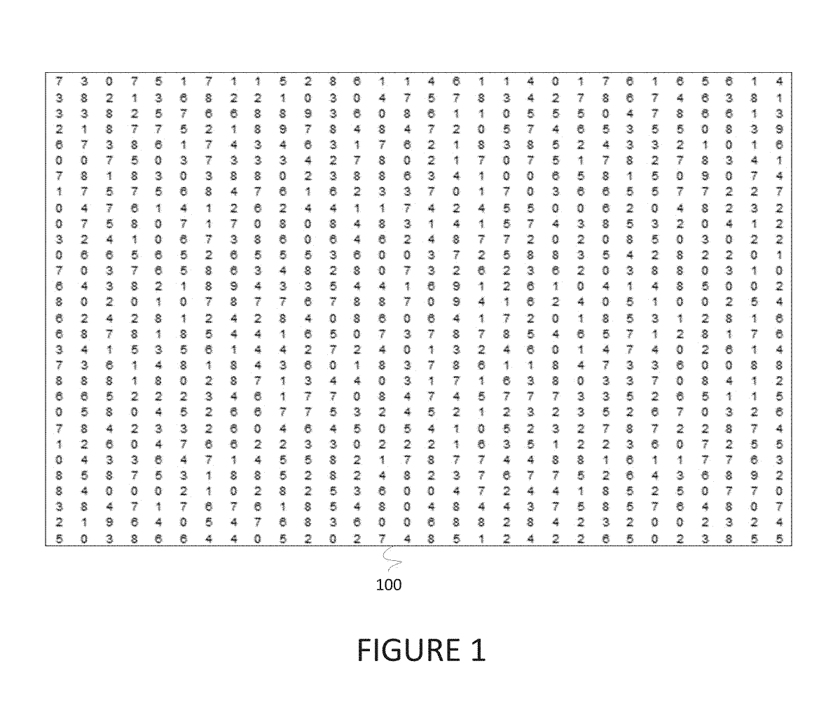

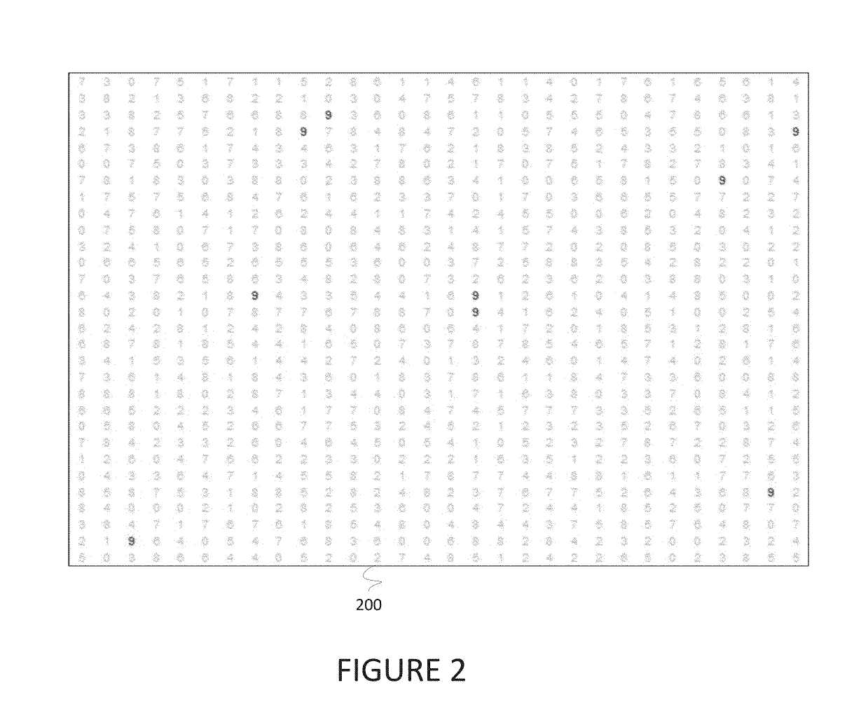

FIG. 1 is a conventional display output 100. A number of options may be displayed in the display output 100, but none is easily discernible. In many situations, even if candidate solutions can be generated, they cannot be easily discerned from one another due to a lack of effective visualization techniques. FIG. 2 is a visual map 200 according to some embodiments. In the visual map 200, candidate solutions (the “9” items) are clearly indicated. The candidate solutions are clearly discernible as opposed to the non-candidate solutions.

For some embodiments, a system and method for complex decision making and decision-making support is described. The system and method includes a computer executing an algorithm or set of algorithms to one or more of the following processes in order to augment human intelligence with artificial intelligence and visualizations. The system and method includes a computer executing and algorithm or set of algorithms to collect data and relevant comparison and/or benchmark data to compare performance of an entity against known performance data for relevant comparisons. The system and method also includes a computer executing an algorithm or set of algorithms to automatically update, refine and generate new relevant benchmarks based on inputs from users of the system over time and automated analysis by the system. The system and method also includes a computer executing an algorithm or set of algorithms to compute a multitude of additional derivative dimensions based on the generated or input data and other data available to the system. The system and method also includes a computer executing an algorithm or set of algorithms to compute a multitude of predictive analytics representing the potential individual and potential collective future states which may include one or more anticipated changes in the system, and/or optional objectives. The system and method also includes a computer executing an algorithm or set of algorithms to create a dynamic, interactive visualization or set of visualizations which enable the user to understand the entire landscape of the multitude of predicted outcomes across multivariate dimensions; to explore the impact of one or more filters on the collective set of predicted states; to understand the obvious and non-obvious impact on available results based on the interaction between the filters; to discover their own public and private preferences for the filters; to collaborate with other users to produce a consensus on the decision and/or adjustments to one or more inputs or filters and/or the decision; and apply the filters to identify one or more future states for further action, based on a combination of individual and aggregate data and values, both of which may be either public or private to the user; and to produce detailed and summary analysis of the decision space on demand. The system and method also includes a computer executing an algorithm or set of algorithms to automatically compute extensions, refinements and updates to public and private data, values, algorithms and derivatives thereof.

Embodiments can include: 1) A single decision based upon user interaction in modifying control importance. 2) A small set of decisions where the user picks the final solution. 3) A subset of top decisions from the total candidate set. In these embodiments, the user is interacting with the initial larger total solutions and prioritizing or re-prioritizing factors based on reaction to the candidate solutions.

Embodiments may apply to multiple use cases where there are large numbers of potential choices, or decisions about items that each have large numbers of attributes that must or should be considered (e.g. each item is multivariate or multidimensional).

In some embodiments, should a user attempt to find solutions through a simple Brute Force calculation of all possible solutions, based on the number of independent factors, the total number of theoretical combinatorial candidates is easily so vast in number that it impossible to compute the entire set. The problem with brute-force algorithms is that the time it takes for the algorithm to complete (known as time complexity) grows exponentially with problem size, which means the growth of the problem is so fast that even the fastest computers require an unacceptable amount of time to solve them. This is a fundamental problem in computing, and is called combinatorial explosion. The practical result is that the number of problems the Brute Force algorithm strategy can be applied to is fundamentally limited. Additionally, in the future, should the set become computable, the set would be so vast in number that it would be impossible choose from the set in an intentional, time-bound way. Further, hidden in this set would be some valuable solutions, but mostly non-valuable solutions. Therefore, some method is needed to reduce the set without losing the most valuable solutions.

The current state of the art doesn't allow such a way to factor through all the inputs, controls and combinations to find a decision. Embodiments may include generation and pruning of the graph that make the candidates for decisions computable and usable by the end user.

A generation process to either a) import a predefined set from another system; or b) create the candidate set on potential decisions through an approach based on Enumerative Combinatorics based on the number of dimensions of the decisions and the width of the ranges of each dimension. This generation requires a proactive pruning process to reduce the candidate set by combining any or all of the items described as (1), (2), (3), and (4) below.

(1) Enumerative combinatorics, where C is the function calculating the total number of combinations (a combination is an unordered list of items, specifically meaning that the order of items selected is not important, as opposed to permutations where order of items in the list is important). In this example, n represents the total number of objects to pick from and r represents the number of objects chosen for each combination.

$$C ( n , r ) = \frac{n !}{r ! ( n - r ) !}$$

In an example where the total number of objects to choose from (n) equals four (4) and the number of objects chosen for each combination equals two (2) the formula yields a total unique number of combinations (again where order of the objects is not important) to be six (6)

Importantly, this equation yields rapidly increasing numbers of combinations as n increases, commonly known as a ‘combinatorial explosion’. As an example, with n=eight possible decisions (a doubling of the original number), the number of combinations with r=2 is 28. As another example, with n=16, and again r=2, the number of combinations=120. A trivial example doubling n a small number, say a total of 10 times yields 4,096 objects, with exactly 8,386,560 combinations, which is a low number but instructive as it illustrates how quickly this problem scales.

(2) Exponential Generating Functions (EGF) are used to describe families of combinatorial objects based on enumeration of combinatorial structures on finite sets. Specifically, in this case, we are interested in the “combinations” of the elements rather than the “permutations” as in practice the permutations are shown to be equivalent and not required for a decision. Some examples of basic EGFs are:

$$F ( x ) = {\sum }_{n = 0}^{∞} ( {f}_{n} ) \frac{{x}^{n}}{n !} ; or F ( x ) = {\sum }_{n = 0}^{∞} ( {f}_{C ( n , r )} ) ; or {\sum }_{n = 0}^{∞} ( {f}_{C ( n , r ) = \frac{n !}{r ! ( n - r ) !}} )$$

The number of combinatorial objects of size n is therefore given by the coefficient of xⁿ.

The above operations can be used to enumerate common combinatorial objects such as graphs (also known as trees), where each unique combination would be a single node on the graph. Graphs are made up of nodes linked by edges (lines that connect only two nodes) such that there are no loops between nodes.

In the case of decisions, ‘n’ is equal to the product of the number of elements in each dimension of the decision being evaluated, multiplied by the similar result for each dimension to get the total number of combinations.

n=n! =(n)(n−1)(n−2)(n−3)(n−4)(n−5) . . . (3)(2)(1)

With large dimensionality and even small number of elements for each dimension, n grows very large so the complete set of objects generated by the combinatorial function grows intractably large and is not computable. This is a well-known problem in combinatorial mathematics

(3) The strategies derived from branch & bound algorithms. Branch and Bound algorithms are form of recursive algorithms typically used in integer and mixed integer programming to find optimal solutions in large combinatorial spaces. These algorithms enable systematic enumeration of all candidate solutions, while discarding large subsets of candidates that are not allowed by using upper and lower estimated bounds of the quantity or quantities that could be optimized. This is a helpful strategy to overcome the combinatorial explosion problem, and avoid creating an NP-Complete or NP-Hard problem. In this system and method, we eliminate the requirement of optimization, while developing one or more bounding functions to reduce the number of combinations and make the problem computable while also enabling the human-in-the-loop decision model. To achieve this goal, we implement strategies related to mixed integer programming with dynamically bounded variables to create weak bounding functions. This strategy intentionally produces values far from the optimum. With the first major bound that may be implemented in some embodiments is choosing the set of combinations vs. permutations, material reduction in the number of nodes is achieved. Additional strategies including relaxation of other constraints on one or more dimensions of the candidate space help further. By leaving out some constraints of a potential optimization problem and also using weak bounding to intentionally enlarge the set of feasible solutions, we further reduce the computation required to evaluate the candidate space. There may be other strategies available.

A typical branch and bound algorithm: (a) Assume the function to be optimized is: 5X₁+4X₂+5X₃+4X₄; subject to 3X₁+20X₂+4X₃+4X₄≤90 and Xₙ is binary for n between 1 and 5; and that our goal is to find the maximum result of the function to be optimized. (b) The graph starts at the top layer, labeled X₀. (c) To start off, compute a feasible solution x*. We add layers below existing nodes on the graph, and number the layer n. Each layer of the graph adds two nodes labeled Xₙ below each existing node in the layer above; and the value of Xₙ is set to ‘0’ for the leftmost node and Xₙ is set to ‘1’ for the rightmost node. Construct a graph of four layers, and as each layer is constructed, compute the value of the function (above), then compute the constraint equation. Then at each node, decide if the constraint is satisfied and if it is then the node is kept and the next layer under that node is computed. I not then no additional child nodes in lower layers are calculated. (d) At each iteration of the branch and bound algorithm, we would refer to x* as the incumbent solution and its objective value z* as the incumbent objective. Here, incumbent means “best so far”, and is the means of optimization in the branch and bound algorithm. A basic algorithm can be summarized in pseudo-code as the process of proceeding through the graph. First start by marking the root node as active. While there remain active nodes, elect an active node j and mark it as inactive. Let x(j) and zLP(j) denote the optimal solution and objective of the LP relaxation of Problem(j). Case 1: If z*≥zLP(j) then Prune node j. Case 2: If z*<zLP(j) and x(j) is feasible for IP then Replace the incumbent by x(j). Prune node j. Case 3: If z*<zLP(j) and x(j) is not feasible for IP then. Mark the direct descendants of node j as active. End While. This is the method for which a graph can be computed while searching for the optimal solution to some specific objective.

The specific functional equations, computed at each node, are unique to each type of decision space, as is the determination of whether to exclude the optimization function or not, and/or the implement the optional application of additional algorithms to refine or reduce the candidate set, and/or use of an output-sensitive-algorithm which adds or removes bounding functions driven by other requirements relating to the user or computing environment.

(4) Dimensionality reduction, clustering and regression algorithms to enable visualization of the multidimensional space in 2-Dimensional (2D) and 3-Dimensional (3D) space. High dimensional data is difficult to visualize directly in native form, although 2D and 3D are relatively easy for people to interpret. To make sense of multidimensional data, the dimensionality must be reduced in some way to fit in 2D or 3D space for presentation to and interpretation by people. This reduction must retain the essential differences of the high dimension information in a material way that is representable in 2D or 3D space, such that the 2D or 3D space presents the information but visually represents more than two or three dimensions of the data. Various algorithms that can be used for this function, including but not limited to K-Nearest Neighbors, K-Means, Minkowski weighted k-means, t-SNE, Principal Component Analysis, etc.

As an example, a common algorithm for clustering, the K-Means Algorithm takes a 2D plot of solutions and then uses an iterative refinement technique with two main steps (Assignment, and Update) to determine which cluster a solution (or data point) should be assigned to. There are many methods to compute the distance between points and their neighbors for the purpose of assigning points to cluster. In this example, we use the common least squared Euclidean distance. In this example, once all the clusters are computed and the algorithm has converged, the points are plotted on a 2D plane. This approach is generalizable to higher dimension data. The simplified version of the algorithm is:

Step 1—Cluster Assignment. Assign each data point to the cluster whose mean has the least squared Euclidean distance, where each data point is assigned to only one cluster.

Sᵢ^{(t)}={xₚ:∥xₚ−mᵢ^{(t)}∥²≤∥xₚ−mⱼ^{(t)}∥²∀ⱼ, 1≤j≤k} (3)

Step 2—Update Cluster Assignment. Calculate the new means to be the centroids of the observations in the new clusters.

$${m}_{i}^{( t + 1 )} = \frac{1}{\vert {S}_{i}^{( t )} \vert} {\sum }_{{x}_{j} ∈ {S}_{i}^{( t )}} {x}_{j} \qquad ( 4 )$$

This process iterates until the algorithm has converged, which is determined to occur when the cluster assignments for the points no longer change

A method is provided where the pruning is required to produce a sufficient candidate set in a user or administrator specified amount of time or resources.

A pruning process is provided that reduces the candidate set to a size where the user can apply further control to reduce the set.

A process is provided where the number of solutions is user selectable a single, small set such as less than 5, or a larger based upon a user provider top candidate number, or where the top N is based upon a calculated number.

A process is provided that includes pre-pruning and pruning during generation to produce a sufficient set.

A process is provided that includes before calculation pruning to generate a sufficient subset of the total theoretical solution that will contain the major candidates to guide the users to be able to pick a solution.

A visualization and interaction system and method to display and select from the set is provided.

A decision process is provided where an initial set of conditions produces a range of possible candidate solutions. Based upon the candidate solutions, an iterative process operates whereby a user can refine the conditions or add additional conditions to produce a refined set of candidate solutions, and optionally cause the system to generate additional options. The refinement is based candidate solutions characteristics that the user was not aware of or would be considered undesirable based upon their values that were not provided as conditions. The process continues providing candidate solutions that meet the refined conditions, until the set is small enough that the user is able to make a decision (e.g. choose or more items in the set).

A generation process is provided to produce a summary or summaries of the decision.

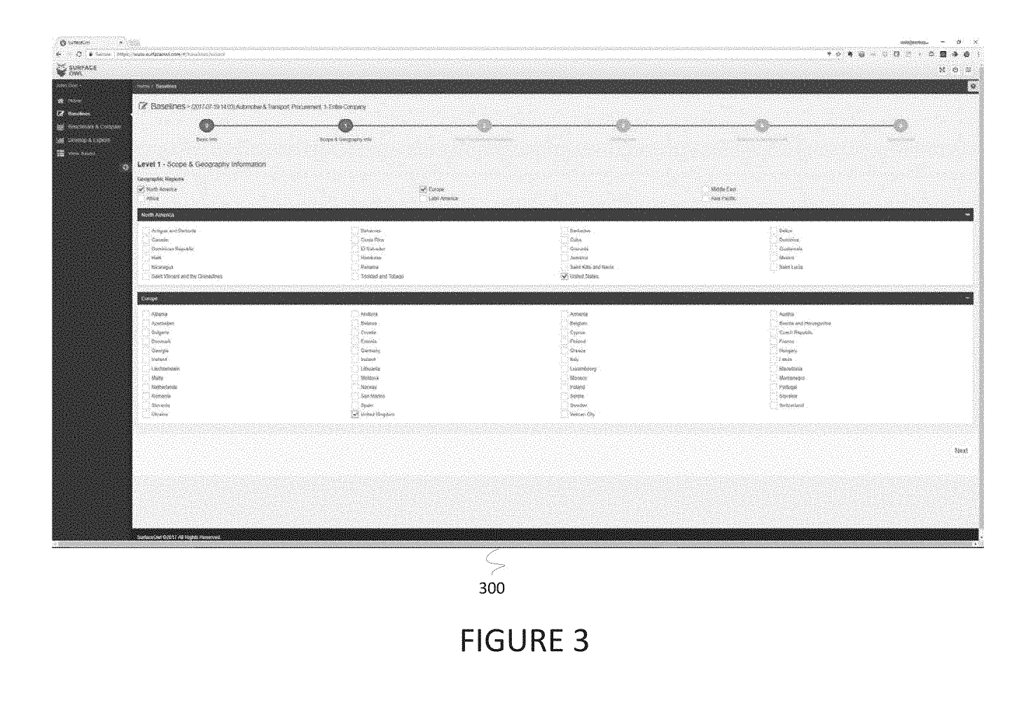

FIG. 3 is an interface 300 according to some embodiments. The interface 300 includes input fields for inputting data to the system. For example, the interface 300 may allow inputting design qualities or ranges of qualities (e.g. materials), design constraints (e.g. minimum or maximum size or weight), geographic data, scope data, procurement statistics data, staffing data, systems and services data, and/or economic inputs (e.g. cost or spend data).

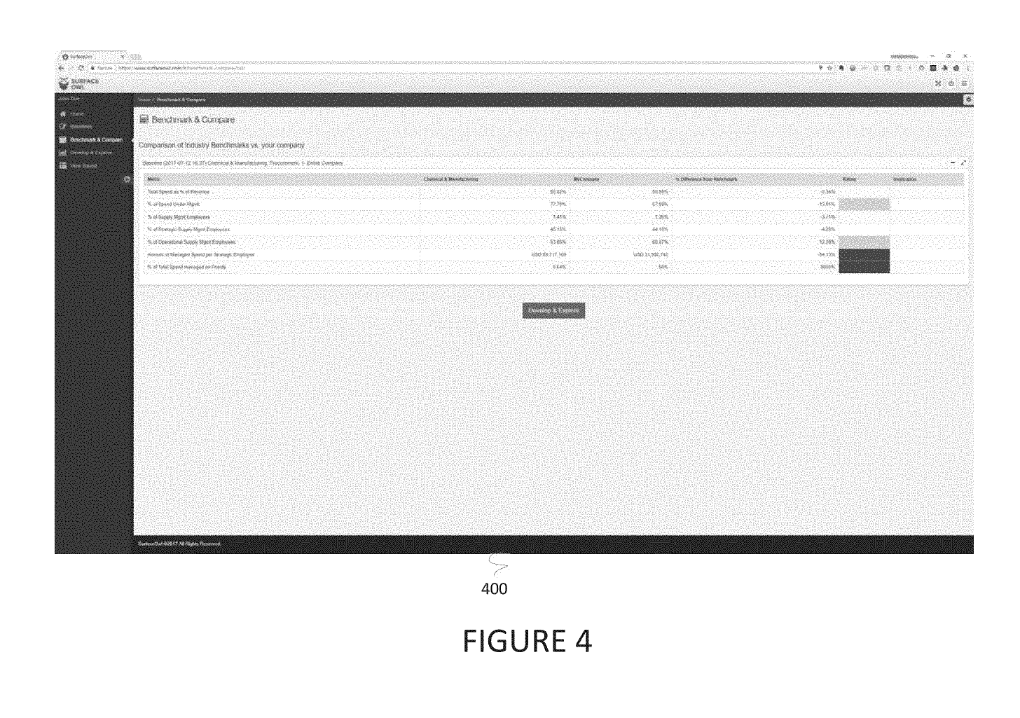

FIG. 4 is an interface 400 according to some embodiments. The interface 400 includes benchmark display. The benchmark display may include textual, numeric, colored, or other display features in order to indicate a benchmark. The benchmark may be determined based on data input in interface 300 of FIG. 3, as well as data input to the system in other ways.

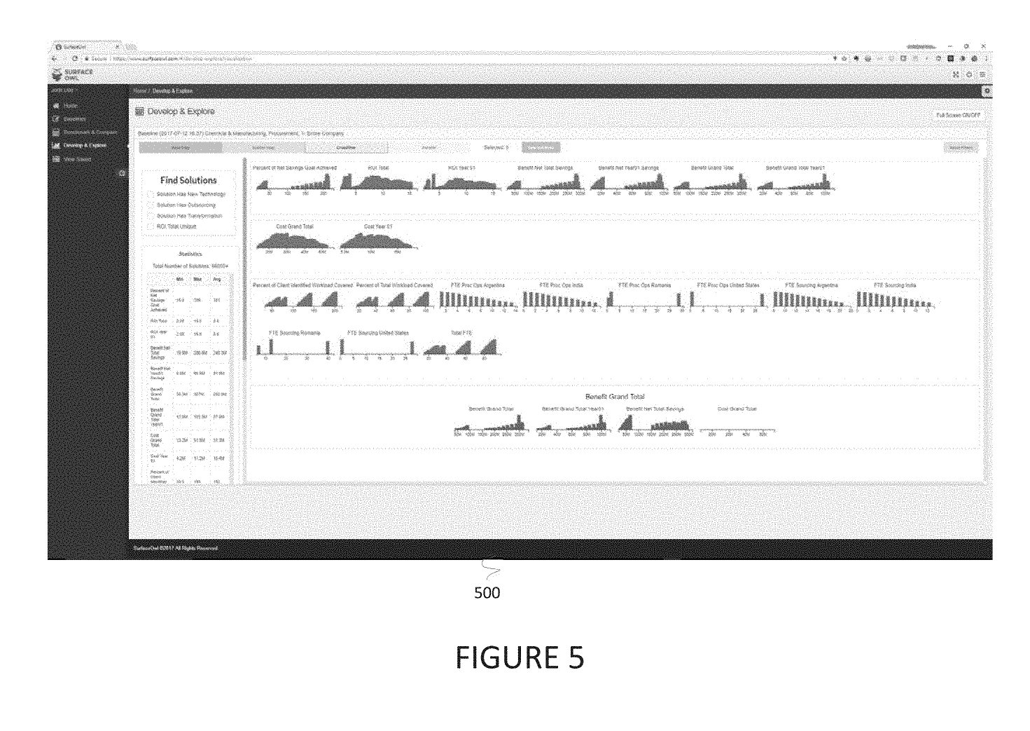

FIG. 5 is an interface 500 according to some embodiments. The interface 500 includes a candidate solution display. The candidate solution display may indicate a distribution of candidate solutions based on a variety of groups (e.g., as shown in FIG. 5 as various charts).

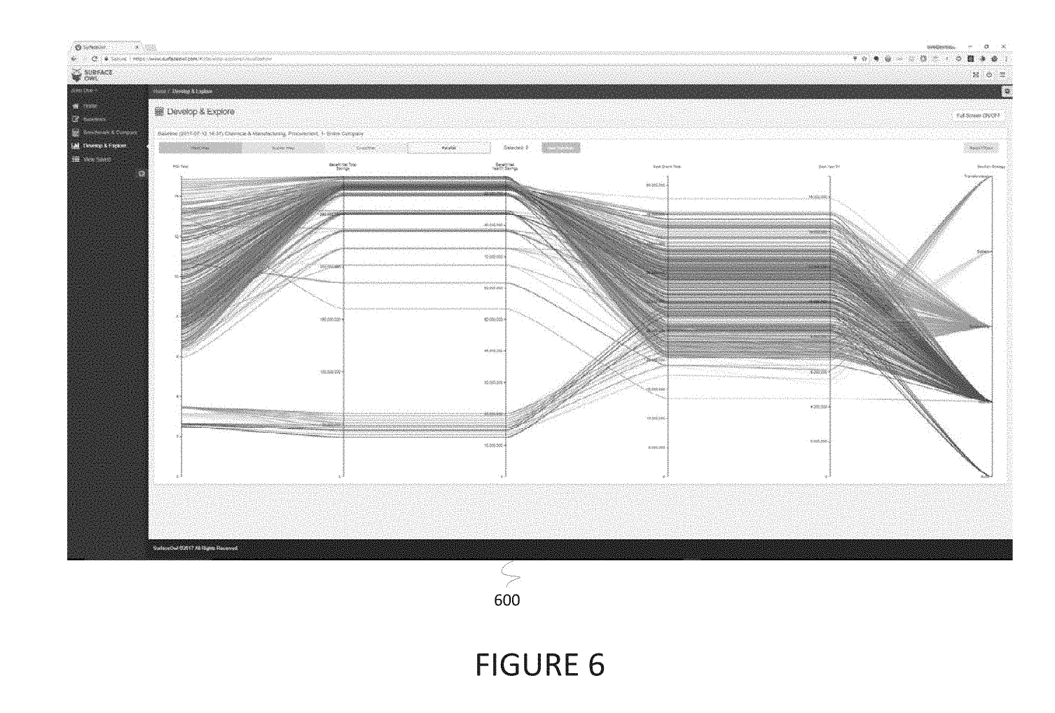

FIG. 6 is an interface 600 according to some embodiments. The interface 600 includes a candidate solution display. The candidate solution display may indicate a distribution of candidate solutions based on a linearization of candidate solutions across various categories (e.g., as displayed in horizontal groupings in interface 600).

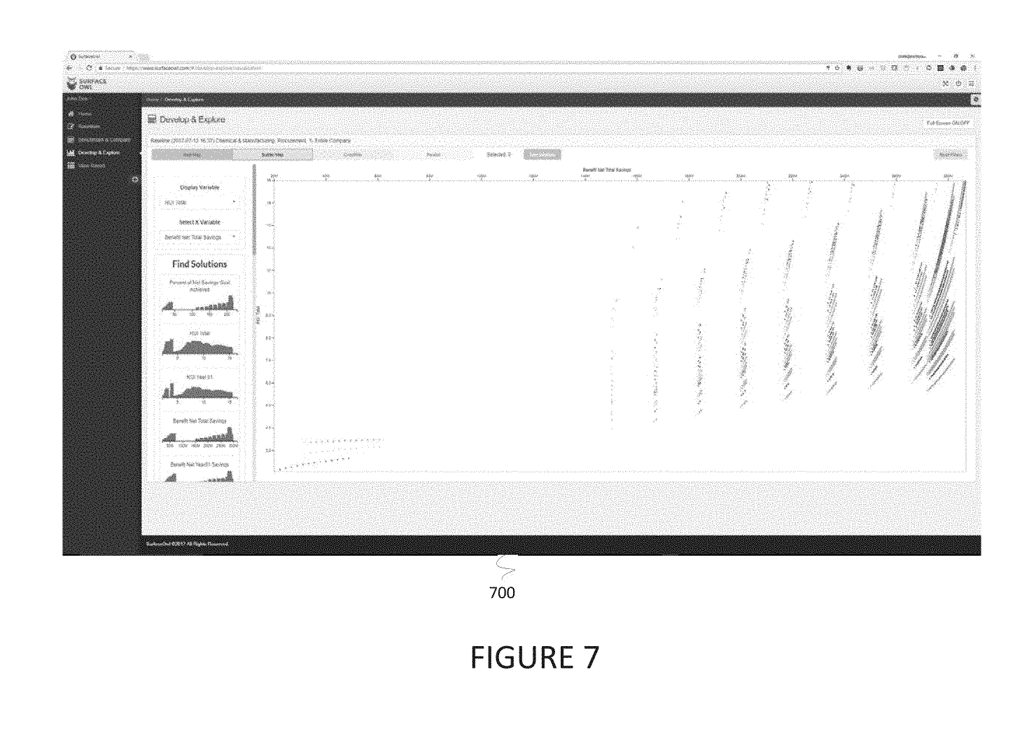

FIG. 7 is an interface 700 according to some embodiments. The interface 700 includes a candidate solution display. The candidate solution display may indicate a distribution of candidate solutions based on various categories (e.g., as displayed in horizontal groupings in interface 700) as well as based on a metric (e.g., as displayed in vertical grouping in interface 700). The candidate solutions may be displayed based on clustering over some metric for the candidate solutions.

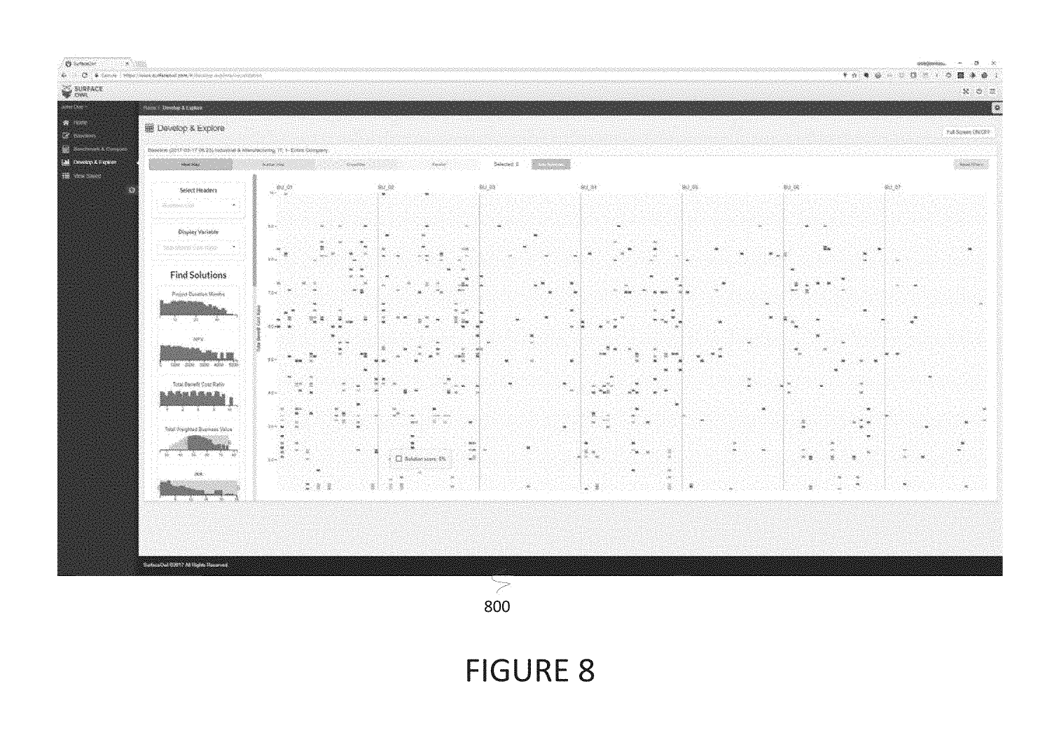

FIG. 8 is an interface 800 according to some embodiments. The interface 800 includes a candidate solution display. The candidate solution display may indicate a distribution of candidate solutions based on various categories (e.g., as displayed in horizontal groupings in interface 800) as well as based on a metric (e.g., as displayed in vertical grouping in interface 800). The candidate solutions may be displayed based on clustering over some metric for the candidate solutions.

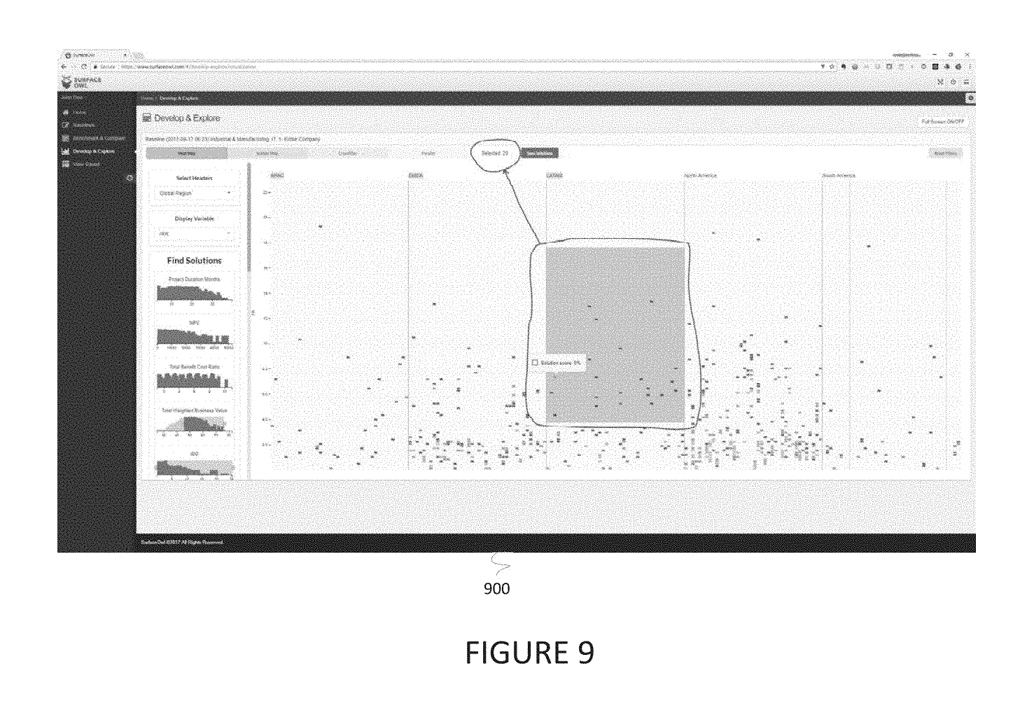

FIG. 9 is an interface 900 according to some embodiments. The interface 900 includes a candidate solution display. The candidate solution display may indicate a distribution of candidate solutions based on various categories (e.g., as displayed in horizontal groupings in interface 900) as well as based on a metric (e.g., as displayed in vertical grouping in interface 900). The candidate solutions may be displayed based on clustering over some dimension or collection of dimensions for the candidate solutions. A user input field may be provided for changing the categories used in the candidate solution display. A user input field may be provided for changing the metrics used in the candidate solution display. The candidate solution display may include a user input functionality so that the user can select one or more of the candidate solutions by selecting them in the interface 900 (e.g., dragging a polygon over the candidate solutions in the candidate display solution of interface 900) (e.g., as indicated in FIG. 9).

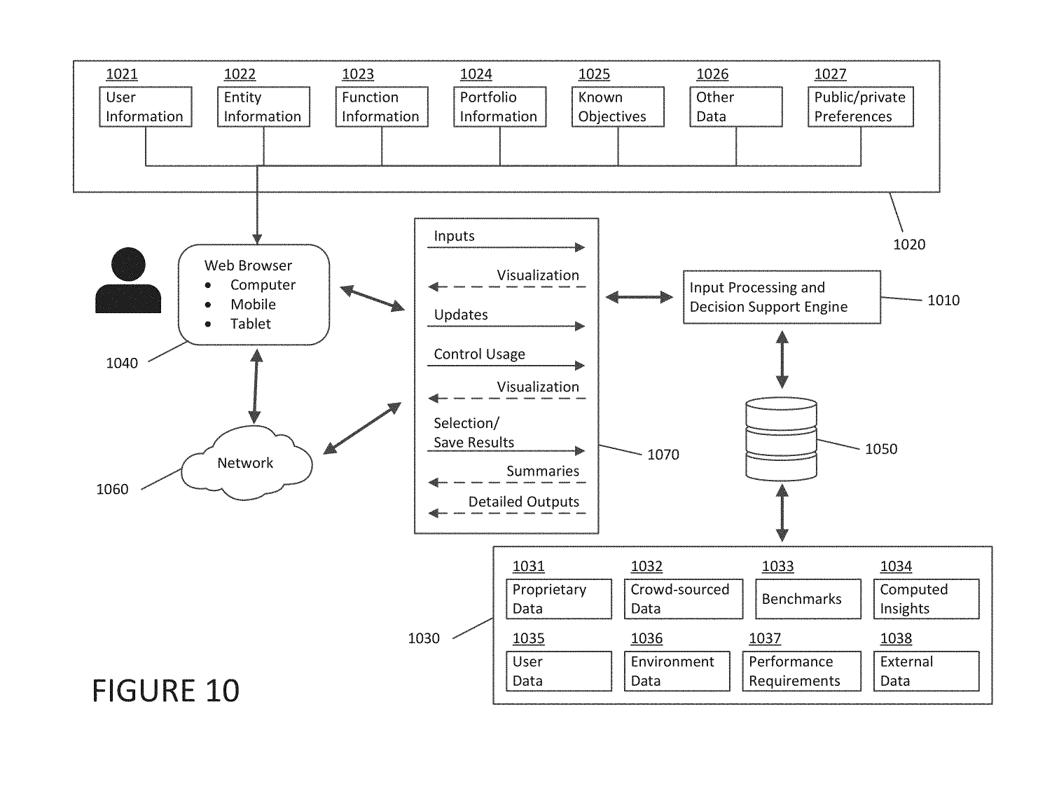

FIG. 10 illustrates an environment according to some embodiments. FIG. 10 illustrates an environment within which the decision support engine introduced here may be implemented. As shown in FIG. 10, a user may use a web browser (1040) in order to access the embodiments of the disclosed technology. In some embodiments, the web browser (1040) may have access to a local database (1020) that comprises various input parameters and data. For example, the user may be able to access, via the web browser, user information (1021), entity information (1022), function information (1023), portfolio information (1024), known objectives (1025), other data (1026) and public and/or private preferences (1027). In some embodiments, the web-browser (1040) may be connected to a network (1060, e.g., physical, Wi-Fi or cellular), and both entities may be configured to interact with the input processing and decision support engine (1010), using, for example, the commands (1070) shown in FIG. 10.

In some embodiments, the input processing and decision support engine (1010) may have access to its own databases (1050, 1030) or a shared databases (1050, 1030), which the user may access (either directly or indirectly) using the web-browser. In an example, the input processing and decision support engine can access proprietary data (1031), crowd-sourced data (1032), benchmarks (1033), computed insights (1034), user data (1035), environment data (1036), performance requirements (1037) and external data (1038), which is may use to advantageously provide data decisioning based on the user requests.

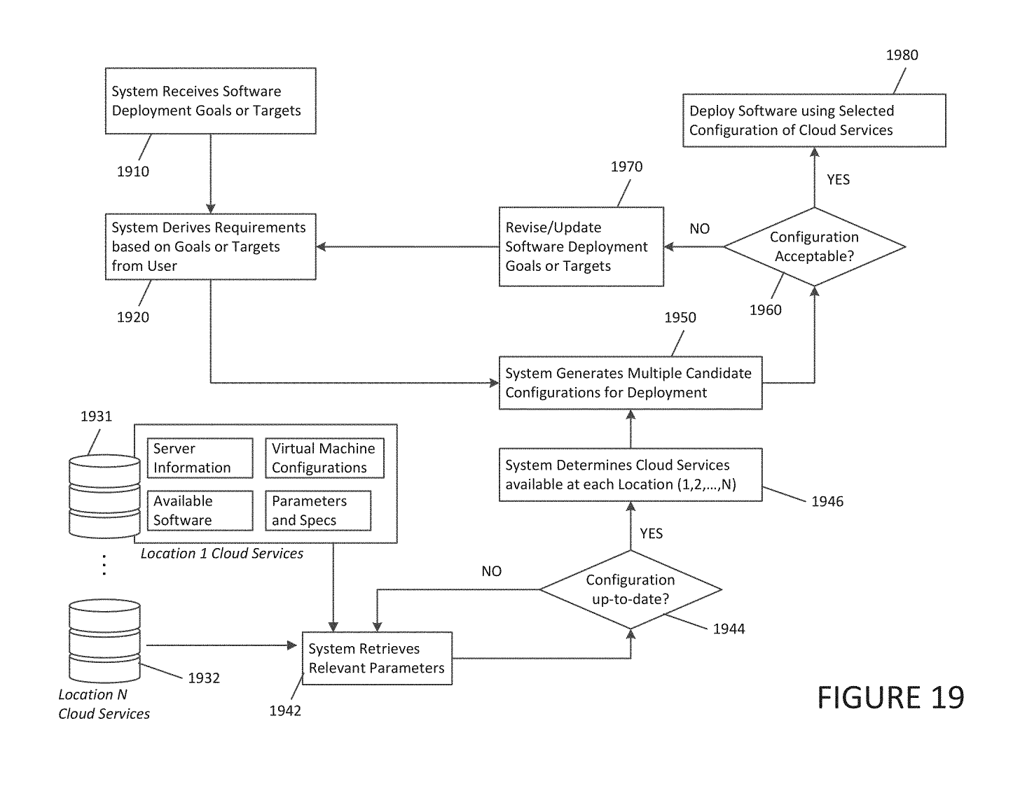

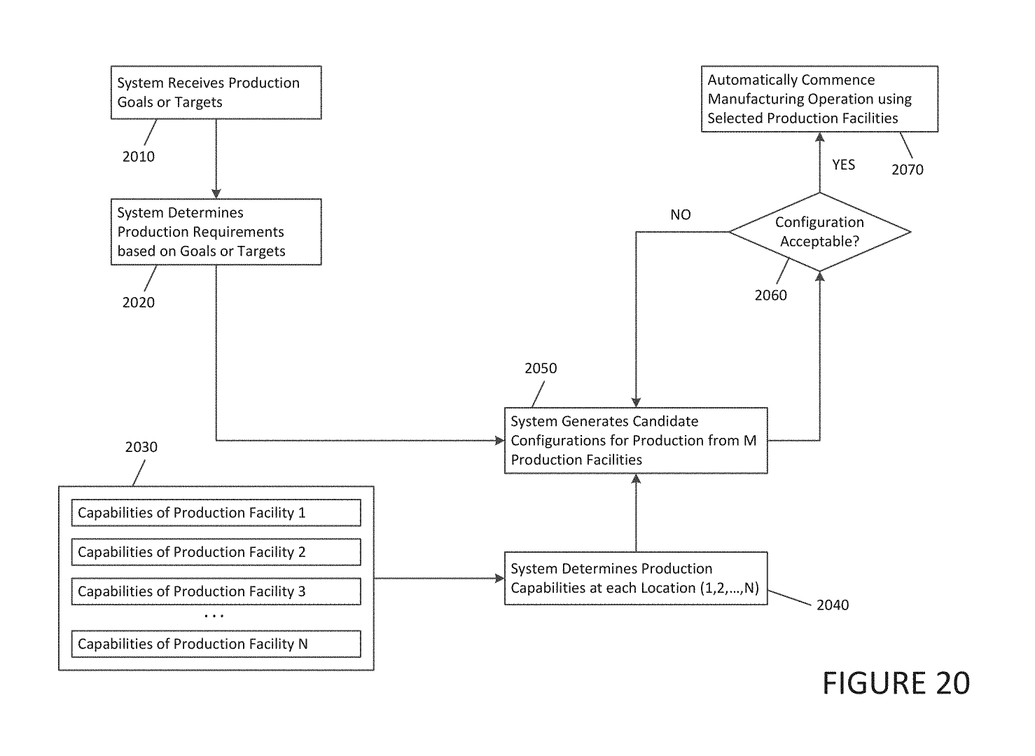

As discussed in the present documents, embodiments of the disclosed technology are able to provide high-dimensional data decisioning services, which in the example shown in FIG. 10, would include the intersection of data elements (1021, 1022, . . . , 1027) from the user's local database (1020) and the remote (or server-side) database (1030) with its data elements (1031, . . . , 1038). The commands (1070) between the user and the input processing and decision support engine (1010) illustrate some features of the supported functionality, which includes visualizations, summaries and detailed outputs that are generated by the server-side based on user inputs, updates, controls and selections. FIGS. 19 and 20, for example, illustrate specific technical problems that may be solved using the framework described herein.

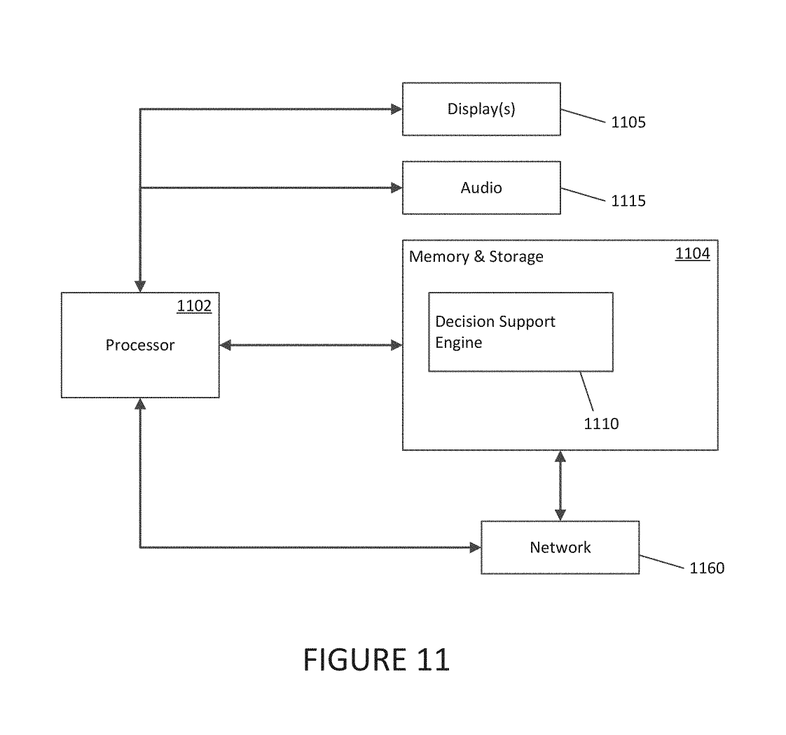

FIG. 11 illustrates a user device according to some embodiments. FIG. 11 illustrates a functional diagram showing a decision support engine being implemented on a computing device in accordance with some embodiments. In an example, and as shown in FIG. 11, the computing device may include a processor (1102) and a memory and/or storage (1104), in addition to input and output functionality, e.g., audio components (1115) and one or more displays (1105). In some embodiments, the audio (1115) may provide both input (e.g., microphone) and output (e.g., speaker) functionality. In some embodiments, the display (1105) may similarly provide both input (e.g., touch screen with or without a stylus) and output (e.g., display or projection,) functionality.

In some embodiments, the decision support engine (1110) may be part of the memory and/or storage (1104), whereas in other embodiments, it may be co-located with one or more processors (including, for example, the processor 1102 shown in FIG. 11). Embodiments of the disclosed technology may implement the decision support engine (1110) in hardware, software or a combination of both.

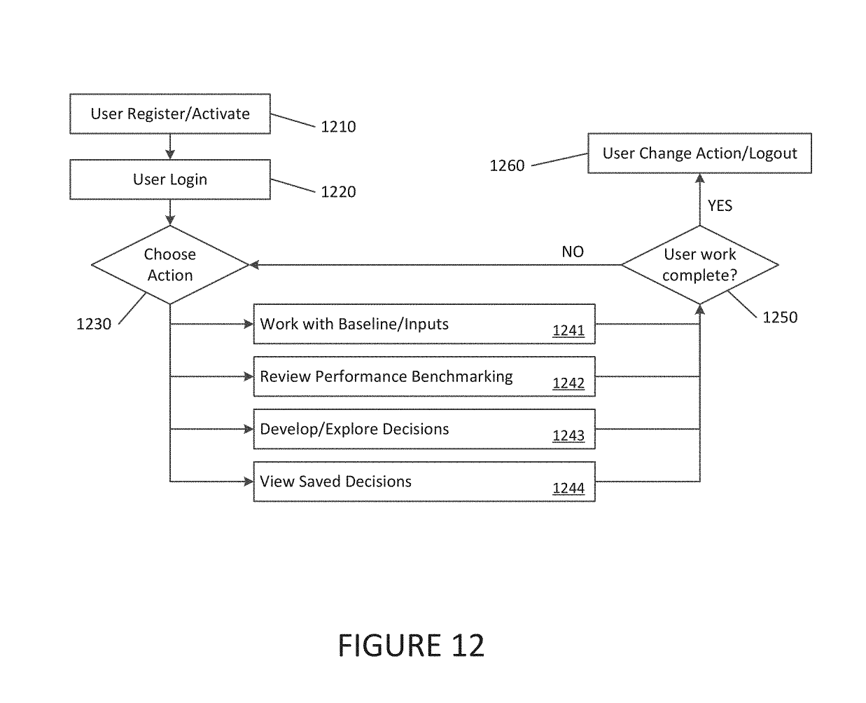

FIG. 12 illustrates an input processing and decision support engine according to some embodiments. FIG. 12 illustrates a flow chart showing a technique for user registration, login, and interacting with the decision support engine. As shown therein, the user registration and/or activation (1210) starts the exemplary interaction, and is followed by the user logging in (1120). In some embodiments, the user may now choose an action (1230), which can include working with the baseline and/or inputs (1241), reviewing performance benchmarking (1242), developing or exploring decisions (1243), or viewed saved decisions (1244). For example, the various actions described in FIG. 12 may be supported using the remote database (1050) and data elements (1031, 1032, . . . , 1038) shown in FIG. 10.

The exemplary interaction then proceeds to checking whether the user has completed their work (1250). If they have not, and wish to choose additional actions to perform, control is passed to the selection of the action (1230). However, if the user has completed their work, then the user either changes their action or logs out (1260).

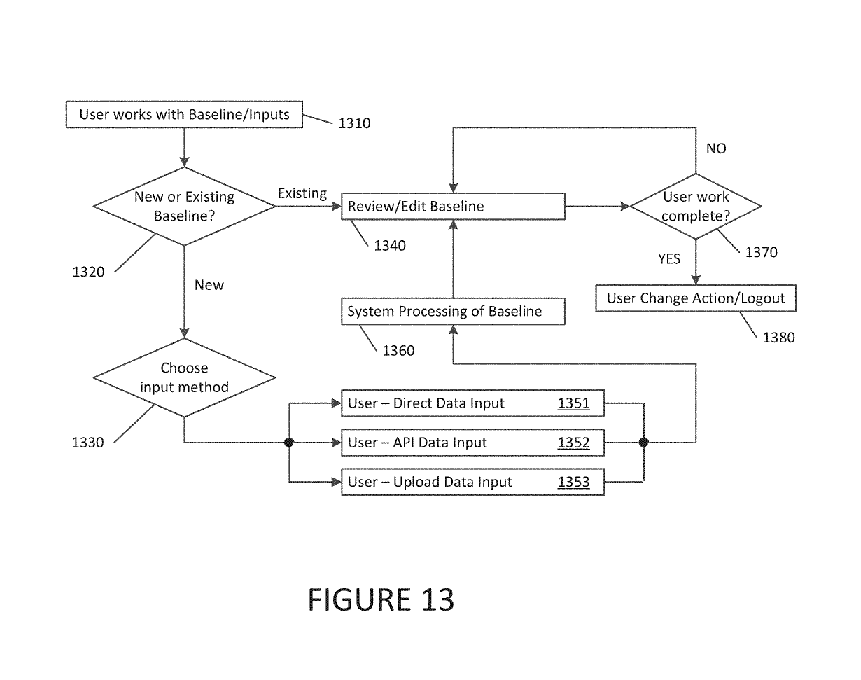

FIG. 13 illustrates a process for working with baseline/inputs according to some embodiments. FIG. 13 illustrates a flow chart showing a technique for providing data related to a decision or decisions to the decision support engine, in accordance with some embodiments. This example includes some features and/or components that are similar to those shown in FIGS. 10-12, and described above. At least some of these features and/or components may not be separately described in this section.

As shown in FIG. 13, the interaction begins with the user requesting to work with the baseline and/or inputs (1310). The user is then queried (1320) as to whether they want to work on a new baseline or an existing baseline. If the user chooses to work on an existing baseline (“Existing” path), they are then able to review and/or edit the existing baseline (1340). In some embodiments, the actions (1241, . . . ,1244) enumerated in FIG. 12 may be available to the user at this point. In other embodiments, the user may now be able to access the data in both the local database (1020) and the remote/server database (1030, 1050) shown in FIG. 10.

Alternatively, the user may elect to work on a new baseline (“New” path), which would require the user to choose an input method (1330). In some embodiments, the supported input methods include a direct data input (1351), an application programming interface (API) data input (1352), an uploaded data input (1353), or any combination of the aforementioned choices. Having selected an input method, and inputted all the relevant data, the system processes the baseline (1360) in view of this updated information. The newly processed baseline may now be reviewed or edited by the user (1340). Upon completion of the review, interaction then proceeds to checking whether the user has completed their work (1370). If they have not completed their work and wish to continue reviewing or editing the baseline, control is passed thereto (1340). However, if the user has completed their work, then the user either changes their action or logs out (1380).

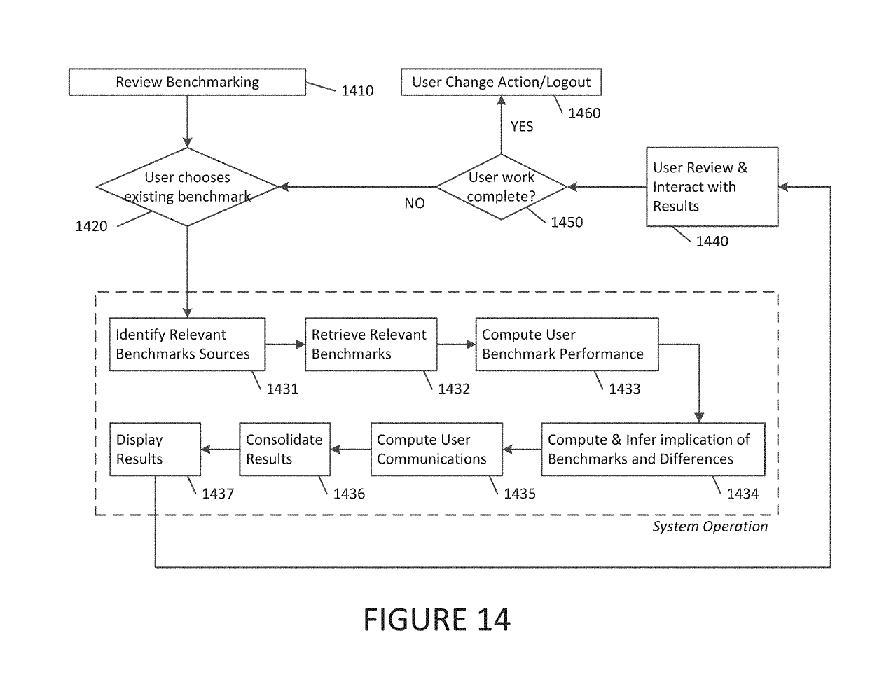

FIG. 14 illustrates a process for reviewing performance benchmarks according to some embodiments. FIG. 14 illustrates a flow chart showing a technique for synthesizing relevant objective performance comparisons relating to the provided data. This example includes some features and/or components that are similar to those shown in FIGS. 10-13 and described above. At least some of these features and/or components may not be separately described in this section.

A shown in FIG. 14, the interaction begins with the user requesting to review a benchmark (1410) and choosing an existing benchmark (1420). If an existing benchmark is not selected (not shown in FIG. 14), the interaction for reviewing benchmarks is terminated. In some embodiments, the selection of a benchmark by the user triggers some actions (or operations) on the system- or server-side. For example, the system may identify relevant benchmark sources (1431), retrieve the relevant benchmarks (1432), compute user benchmark performance (1433), compute and infer implications of the benchmarks and any differences or deviations that may exist (1434), compute user communications (1435, e.g., responses to specific requests or queries made by the user), consolidate the results (1436) and display the results (1437). As shown in FIG. 14, the operations (1431, . . . , 1437) are performed by the system or server-side (as indicated by the dashed line surrounding these operations). In some embodiments, one or more of the various enumerated options may rely on the data in both the local database (1020) and the remote/server database (1030, 1050) shown in FIG. 10.

The user is now able to review and interact with the results (1440), as described in other sections of the present document. Upon completion of the review, interaction then proceeds to checking whether the user has completed their work (1450). If they have not, and wish to choose an additional benchmark to review, control is passed thereto (1420). However, if the user has completed their work, then the user either changes their action or logs out (1460).

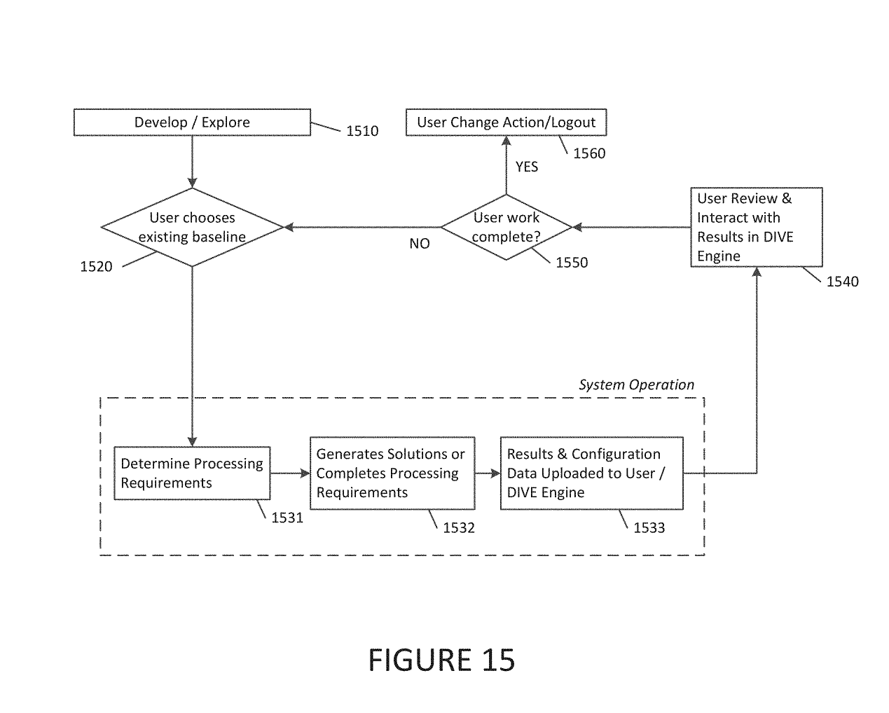

FIG. 15 illustrates a process for developing/exploring decisions according to some embodiments. FIG. 15 illustrates a flow chart showing a technique for generating results or completing required processing in accordance with some embodiments, and then completing further processing to enable user review and interaction with the result set, in accordance with some embodiments. This example includes some features and/or components that are similar to those shown in FIGS. 10-14 and described above. At least some of these features and/or components may not be separately described in this section.

As shown in FIG. 15, the user may choose an existing baseline (1520). If an existing baseline is not selected for development and/or exploration (not shown in FIG. 15), the interaction in this flowchart is terminated. In some embodiments, the selection of a baseline by the user triggers some actions (or operations) on the system- or server-side that may include determine processing requirements (1531). In some embodiments, determining the processing requirements is based on correlating the parameter values in the selected (or chosen) baseline and comparing them to available resources, benchmarks, etc.

The triggered operations may further include generating solutions or completing the processing requirements (1532) and uploading the results and/or confirmations to the user and corresponding DIVE engine (1533). The user is now able to review and interact with the results in the DIVE engine (1540), as described in other sections of the present document. Upon completion of the review, interaction then proceeds to checking whether the user has completed their work (1550). If they have not, and wish to choose an additional baseline to review, control is passed thereto (1520). However, if the user has completed their work, then the user changes their action or logs out (1560).

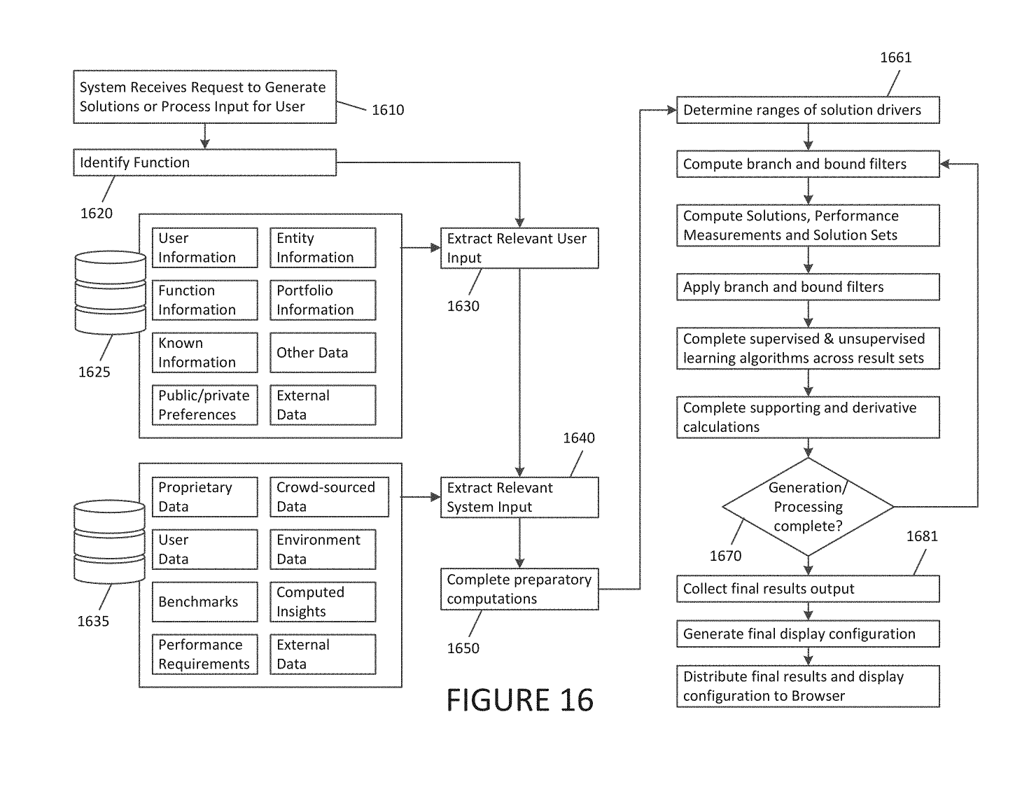

FIG. 16 illustrates a process for generating solutions and processing inputs. FIG. 16 illustrates a flow chart showing a technique for generating results or completing required processing in accordance with some embodiments. This example includes some features and/or components that are similar to those shown in FIGS. 10-15 and described above. At least some of these features and/or components may not be separately described in this section.

As shown in FIG. 16, the process begins with the system receiving a request to generate solutions or process inputs for a user (1610). The system the identifies the specific function to be performed (1620) based on the request. Then, relevant user input is extracted (1630) from a first database (1625), which in some embodiments, may correspond to the database (1020) in FIG. 10 since it shares similar data elements. Following that, relevant system input is extracted from a second database (1635) , which in some embodiments, may correspond to the other database (1030, 1050) in FIG. 10 since it shares similar data elements. Preparatory computations are completed (1650) based on the relevant user and system input that was extracted.

In some embodiments, the process shown in FIG. 16 then implements a series of operations that are part of the generation/processing step. For example, the generation and/or processing include determining ranges of solution drivers (1661), computing output-sensitive computing algorithms which may include potential branch and bound or Bloom filters or other filters as required, computationally generating a multitude of solutions, performance measurements and solutions set(s), applying the filters, completing supervised and unsupervised learning algorithms across the result set(s), and completing supporting and derivative calculations.

The system then checks whether the generation or processing task has been completed (1670), and if it has not, then process control returns to computing filters and generating additional solutions until the task is complete. Upon completion of the requested generation or processing, the system collects the final results output (1681) dynamically generates a final display configuration and distributes the final results and display configuration where it is displayed to the user in a browser.

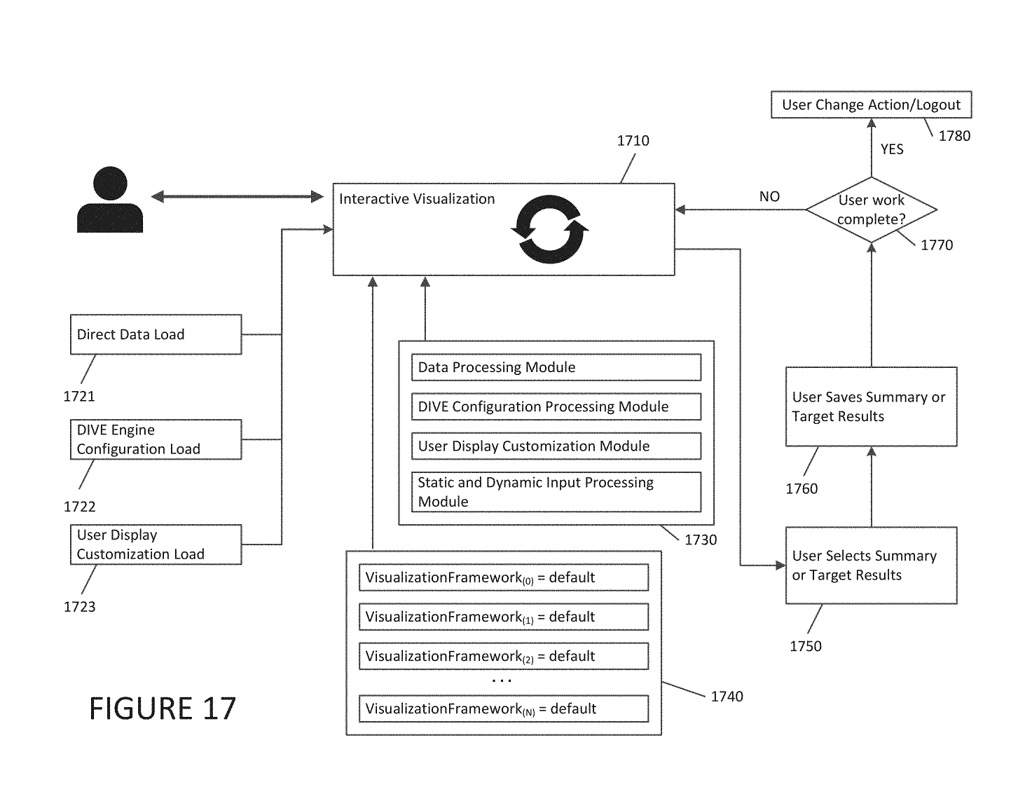

FIG. 17 illustrates a Dynamic Interactive Visualization Explorer (DIVE) engine according to some embodiments. FIG. 17 illustrates a flow chart showing a technique for providing results to a visualization engine viewed by a user, the user iteratively interacting with the visualization, and the user saving information from the DIVE engine in accordance with some embodiments. This example includes some features and/or components that are similar to those shown in FIGS. 10-16, and described above. At least some of these features and/or components may not be separately described in this section.

The flowchart shown in FIG. 17 is triggered by the user interacting with the interactive visualization module (1710), which provides results of high-dimensionality decisioning to the user based on a number of different inputs. In some embodiments, the visualization module includes traffic loads of different types (1721, 1722, 1723), visualization frameworks (1740) and one or more processing modules (1730). The interactive visualization module (1710) assimilates the data from the different sources and presents summary or target results for user selection (1750). The user may (optionally) save the summary or target results (1760). In some embodiments, advantageously enabling visualization of the solution space within the capabilities of available technology may result in the fact that the results are interpretable by the user through visualizations to make informed decisions about the decision space.

The system now checks whether the user has completed their work (1770). If they have not (the “NO” path), and wish to choose to visualize additional solutions, etc., control is passed to the interactive visualization (1710) module. However, if the user has completed their work, then the user changes their action or logs out (1780).

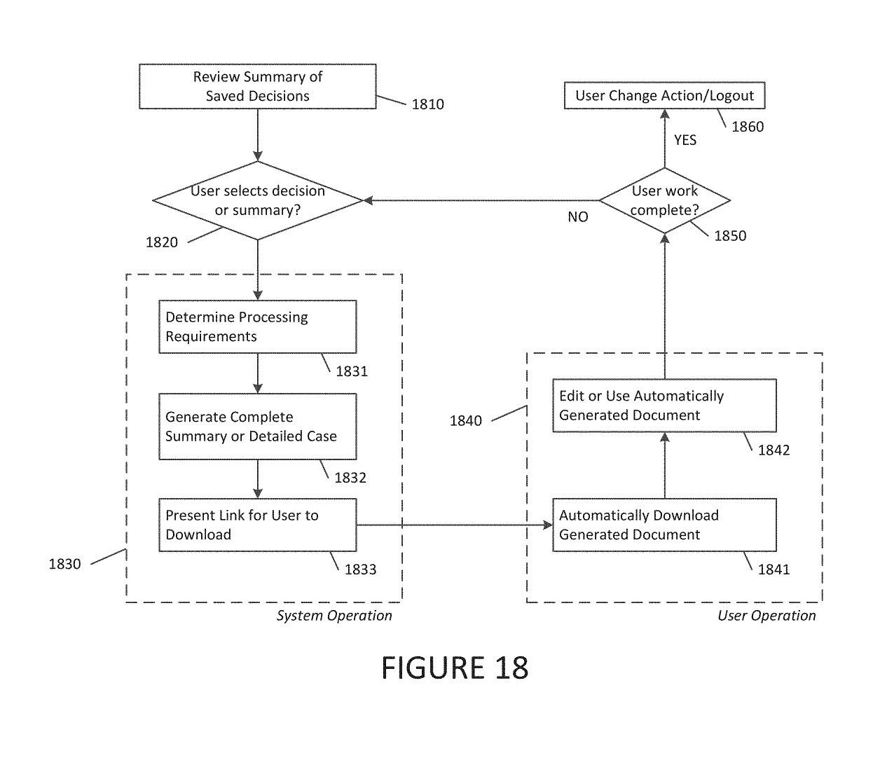

FIG. 18 illustrates a process for viewing saved decisions according to some embodiments. FIG. 18 illustrates a flow chart showing a technique for generating, viewing and downloading automatically generated summaries and/or detailed descriptions of the decisions saved and supporting information in accordance with some embodiments. This example includes some features and/or components that are similar to those shown in FIGS. 10-17, and described above. At least some of these features and/or components may not be separately described in this section.

The process may begin with the user selecting a decision or summary (1810), which triggers a first set of operations (1830) performed by the system- or server-side and a second set of operations (1840) that are performed by the user. Upon completion of the second set of operations, the process checks whether the user has completed their work (1850). If they have not (the “NO” path), and wish to choose review additional decisions or summaries, control is passed thereto (1820). However, if the user has completed their work, then the user changes their action or logs out (1860).

In some embodiments, the first set of operations (1830) includes determining processing requirements (1831), generating a complete summary or a detailed case (1840) and presenting a link for the user to download either the summary and/or the detailed case. In some embodiments, the second set of operations (1840) includes automatically downloading the generated document (1841), and editing or using the automatically generated documents (1842).

FIG. 19 illustrates an exemplary use case for deploying software across multiple cloud computing services. This example includes some features and/or components that may incorporate those shown in FIGS. 10-18, and described above. At least some of these features and/or components may not be separately described in this section. The process in FIG. 19 begins with the system receiving software deployment goals or targets (1910). In some embodiments, the software deployment goals or targets may be received as generated from a software requirements specification, from a functional requirements specification, from a quality of service specification. In some embodiments, some or all of the software deployment goals or targets may be provided by a user, such as a software architect or other technical expert user. Then, the system deconstructs the targets or goals into requirements (1920) that will enable the deployment of the software in the cloud.

The use case described in FIG. 19 advantageously enables cloud services from multiple locations to be leveraged and utilized when determining the resources required for the software deployment. In some embodiments, relevant parameters from cloud services at various locations are retrieved (1942). In an example, the cloud services may be characterized by server information, virtual machine configurations, available software packages, and parameters and specs for the infrastructure at that location (e.g., “Location 1 Cloud Services” denoted 1931, and as shown in FIG. 19.).

In order to ensure the efficiently deployment of the software, the system checks whether the cloud service characterizations are up-to-date (1944), which may be critical for certain software packages and deployment. If it is determined that that the cloud service configurations are stale (the “NO” path from 1944), control is passed back to the retrieval of the cloud service parameters and characteristics. However, in the event that that configurations are up-to-date (the “YES” path from 1944), the system is able to determine the cloud services available at each location (1946).

For example, certain software deployments may favor a particular cloud platform implementation (e.g., Amazon Web Services (AWS), Google Cloud Platform (GCP), Azure, IBM), and specific hardware or software packages, and thus the software deployment may necessarily have to be deployed across multiple physical locations and services.

The process is then able to generate multiple candidate configurations for deployment (1950) based on the up-to-date cloud services at each location (1946) and the requirements derived from the software deployment targets or goals (1920). The candidate configurations are analyzed for acceptance (1960), which may result in a selection of one the configurations (the “YES” path from 1960) or a rejection of all the candidates (the “NO” path from 1960).

A candidate configuration may be selected/accepted in a variety of ways. In some embodiments, a candidate configuration may be selected by analyzing all or some of the candidate configurations in a software testing environment. For example, a software testing environment may be maintained that mimics characteristics of the actual cloud services that may be used for software deployment. A candidate configuration may be analyzed in the test software environment by configuring the test software environment according to the candidate configuration, performing testing experiments (e.g., mimicking normal system activities, testing high loads, testing emergency failover events) and determining performance metrics. The performance metrics may include determining quality of service metrics for the candidate configuration, such as the percent of transactions that successfully processed, the average response time for calls made to the software, or some other metric. The candidate configuration with the best performance metrics based on the testing experiments, and in some embodiments also based on a rating formula that combines the performance metrics into a numerical score, may be selected the candidate configuration to be used. In some embodiments the candidate configuration may be selected by a user, such as a software engineer or other expert user.

If one of the candidate configurations is selected (or approved), the system deploys the software using the selected configuration of cloud services (1980). Deploying the software using the selected configuration may be performed in variety of ways. In some embodiments, deploying the software using the selected configuration may include repackaging the software into a defined set of software deployment modules specified as part of the selected configuration. For example, if the selected configuration identifies three five different object code files to be deployed to a particular could service, then the five object code files may be combined into a single deployable software module (e.g., a single web application resource (WAR) file) along with corresponding configuration information for the software deployment module. A secure communication session may be established with the cloud service, and the software deployment module may be transmitted to the cloud service for storage on a web-accessible server. The transmission of the software deployment module to the could service may include further configuration information as specified in the selected configuration. For example, the further configuration information may specify hardware resources (e.g., server model to use, amount of memory to allocate, number of CPU cores to allocate) that should be allocated to the software deployment module. This process of generating a software deployment module, transmitting the software deployment module to a cloud service, and transmitting further configuration information to the cloud service may be repeated for all cloud services and/or deployments specified in the selected configuration.

However, if all the candidates are rejected, in some embodiments, the software deployment goals or targets are revised or updated (1970). The software deployment goals or targets maybe revised or updated in a variety of ways according to various embodiments. In some embodiments, a genetic mutation algorithm or neural network or other use-case specific algorithm may be applied to the software deployment goals or targets to modify those goals or targets by a predefined mutation factor. In some embodiments, a user (e.g., a software architect or other expert user) may revise or update the software deployment goals or targets. The revised or updated software deployment goals or targets are then converted to requirements (1920) so that the process continues until the software is deployed. In other embodiments (not shown in FIG. 19), the system may refresh the cloud service capabilities to determine whether an updated set of configurations are able to meet the requirements for software deployment.

FIG. 20 illustrates an exemplary system for manufacturing across multiple production facilities. This example includes some features and/or components that may incorporate those shown in FIGS. 10-18, and described above. At least some of these features and/or components may not be separately described with respect to FIG. 20. The process in FIG. 20 begins when the system receives production targets or goals (2010), and then determines production requirements based on the goals or targets (2020). The process illustrated in FIG. 20 may include features described with respect FIG. 19. In particular, blocks 2010 and 2020 may be implemented in relevant part as described with respect to blocks 1910 and 1920 of FIG. 19. In some embodiments, the production goals or targets may be generated automatically based on a production manifest, such as a specification document describing characteristics of products to be produced and parameters describing the operations of that production.

The process in FIG. 20 includes the system determining the production capabilities at each location (2040), which may be based on a centralized or distributed database of production facility capabilities (2030). In some embodiments, the capabilities of the multiple production facilities may include different plants in different locations, different machinery that makes different components available at different locations, different cost of labor at different locations, different stockpile of supplies at different locations, different distances between the locations (need to ship components to single place to be assembled, distance to distributor's warehouse, different costs of shipping, etc.).

In some embodiments, the process generates a candidate configuration for production that uses M different production facilities (2050) using the production capabilities at each location (2040) and the production requirements based on the goals or targets (2020). The candidate configuration may be analyzed to determine if it is acceptable (2060). The candidate configuration may be analyzed for acceptability in a variety of ways. For example, the candidate profile may be analyzed using a formula that translates various production metrics (e.g., total production cost, total volume of production, time to market) into a numerical score (e.g., using a predefined utility model), and the candidate configuration may be accepted if the numerical score exceeds a predefined threshold or a variable threshold (e.g., using a decreasing numerical score value with each iteration of block 2050). In some embodiments, a user (e.g., a production manager, financial analyst, or other expert user) may choose to accept the candidate configuration (the “YES” path from 2060).

If the candidate configuration is accepted, manufacturing operations may be automatically commenced using the candidate configuration and the selected M production facilities (2070). Manufacturing operations may be automatically commenced using a variety of techniques according to various embodiments. For example, a secure communications session may be established with a production management server for a first production facility. Production instructions may be generated according to the accepted candidate configuration and transmitted to the production management server. The production management server may use the production instructions to automatically control one or more production machines to create components or finished products as specified in the accepted candidate configuration. In some embodiments, the production instructions may include ladder logic transmitted to the production management server, where separate ladder logic instructions are provided for each production machine present at the first production facility and specified for use in the accepted candidate configuration. The production management server may subsequently transmit the ladder logic instructions to each respective production machine. The production management server may subsequently send an execution command to each production machine to commence processing using the transmitted ladder logic. In various embodiments, the production machines may include 3D printers, lathes, mills, printers, and other physical production machines.

However, if the candidate configuration is rejected (the “NO” path from 2060), the process generates another set of candidate configurations (2050). In some embodiments (and not shown in FIG. 20), the user may either (i) reject the candidate outright, or (ii) object to certain production facilities being used as part of the manufacturing operation; e.g., updated currency or political news may make a specific production facility less attractive, and the high-input and high-dimensionality decisioning embodiments described herein are able to integrate these external factors into the candidate generation process.

The candidate solution display may include interactive user input to force inclusion, exclusion or relative prioritization of candidate solutions of the candidate set. The candidate solution display may also include interactive user input to allow the user to iteratively change the categories and/or metrics for use in the candidate solution display. In some embodiments, blocks 2050 and 2060 may be performed as described with respect to blocks 1950, 1960, and 1970 of FIG. 19. For example, block 2050 may include generating a set of candidate configurations, and block 2060 may include choose one of the generated candidate configurations.

An example according to some embodiments follows.

1. The process begins by a user registering and logging into the system.

2. Targeted Data Collection. Next the users and save the available data into the system through one or more methods that may include: data entry in a form, upload of data through a document or spreadsheet and a user interface on the system, data entry through responses to an online computer entity which in one embodiment, could be a chatbot requesting specific elements of information and/or coaching the user based on previous user inputs and other data available to the system; import or lookup of the data on another computer system through an application programming interface (API), or a combination of these methods that may be done with a single user, or multiple users in collaboration. If there are gaps in required data, in one embodiment, the user(s) then researches required unavailable data, and then enters and saves that data into the system. In another embodiment where there are gaps in the data, the system estimates values and/or ranges of values based on other user inputs and/or other data available to the system.

3. Data Validation. The system completes computation on the inputs as they are provided by the user to determine whether or not the data element meets minimum data validation requirements, which include but are not limited to data type checking (e.g. is the data element is of type integer, and the user enters a string), and then automatically engages the user to correct minimum data validation errors before the user and system can proceed, or accept system provided substitute values.

4. Data Storage. The system and method then executes an algorithm or set of algorithms to store the data in a repository for future use.

5. Data Analysis—benchmarking. In one embodiment, the system and method then executes an algorithm or set of algorithms to analyze the collected data to determine which public and private benchmark data contained within the system is relevant for comparison with the current user's current input data. This relevant data is known hereafter as “benchmarks”, “benchmark data”, and “metrics”.

A. In one embodiment of the benchmarking function, this may include use of public or third party proprietary benchmarks such as business performance metrics which are relevant for a specific combination of business function or industry.

B. In another embodiment of the benchmarking function, the system may execute an algorithm or set of algorithms to compute comparisons of the user data with other user data to provide contextual comparisons with other data sets included in the system, such that individual attribute or derivatives attributes, or collections of the aforementioned can be compared across relevant sets of data in the system.

C. In another embodiment, the system and method executes an algorithm or set of algorithms to compute the text/numeric and/or graphic results of the benchmarks based on the values provided by the user.

D. In another embodiment, the system and method then computes objective valuation summaries based on the difference between the system benchmarks and the users inputs, and then may present the results in a graphical display or for downloading.

6. Benchmarking—Crowdsourcing Refinement and Updating. In one embodiment of the system and method, the system may execute an algorithm or set of algorithms to compute extensions or refinements of the public or third-party proprietary data that are not available in the public or third party proprietary data. As an example, the benchmark or performance metrics which are relevant for a specific combination of activity and other conditions may be refined to reflect results obtained when additional elements collected by the system are factored in, such as existence or absence of certain condition(s), correlations with other public or private benchmarks, etc. In this way, benchmarks are made more precise for future users of the system, and automatically accommodate performance improvements and new condition(s) that may become available.

7. Data Analysis—benchmarking presentation. The system and method then executes an algorithm or set of algorithms to present the user with a summary of the benchmarks in textual form, tabular form, graphical form, or any combinations thereof; and may also be made available in separate electronic or physical form to the user. In one embodiment of the system and method, the system displays a tabular summary of the text/numeric and/or graphic descriptors of the computed benchmark based on the users input, the current benchmark values, the relative difference between the two sets of results, and the objective value statements.

8. Solution Generation and Evaluation. The system and method may execute an algorithm or set of algorithms to combine of some or all of the available benchmark data available in the system or externally, with the user data and computed benchmark comparisons, to execute an algorithm or set of algorithms that may include probability based analysis to compute a multitude of predictive analytics which describe a vast multitude of potential future states for the user. The system and method may include an algorithm or set of algorithms to compute insights and new elements of information required to enable the system and method to function. This may include, but is not limited to critical activities across the plurality of solutions that exist such as applying algorithms to limit the solution space to a universe that is computable within practical requirements, enabling accurate and efficient computation, enabling differentiation of solutions, enabling visualization of the solution space within the capabilities of available technology, and so forth, such that the results are interpretable by the user through visualizations to make informed decisions about the decision space.

A. Intermediate Calculations
i. Get user-inputs
ii. Getbenchmarks—for some decision spaces, there may exist public or private data that can be used as benchmarks to gauge relative score or relative performance against other entities.
iii. iv. Compute functional constants necessary for computing the solution space
v. Compute dimensions and ranges for each dimension required to compute the solution space.
vi. Summarize inputs required by final calculations module and continue processing.

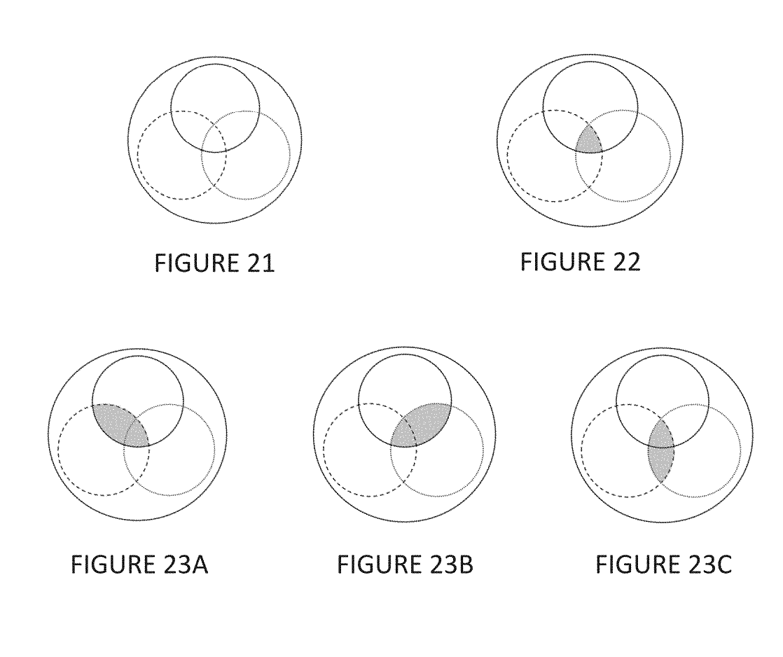

B. Final Calculations
i. Compute solution graph. Enumerate all solution input ranges, and alternative input ranges defined as sets. Compute relevant benchmarks for each node in the graph.
ii. Compute the set of sets which represent the entire potential input ranges for the combinatorial solution space -Ω- and the revised sets representing the same ranges with known boundary conditions. In this embodiment the Set Theory symbol for Intersection (∩) is used for example, although in other embodiments based on the user decision criteria other common set operations may be used, including but not limited to: Union (A ∪ B), Subset of (A ⊂ B), Not a Subset of (A⊂B), Proportional To (A ∝ B)−A=x*B for some constant x, Symmetric Difference (AΔB)—objects that belong to A or B but not to their intersection, etc. FIG. 21 illustrates an example of the Intersection operation.
iii. For each enumerated solution element:
   1. Define inputs from intermediate calculations
   2. Identify Set Ai as the total potential space defined as the product of the ranges of solution element 1
   3. Identify Set B₁ as the total potential solution space defined as the product of the ranges of solution element 1 modify by applying the boundary condition created by the minimum range of solution element 1.
   4. Identify Set C₁ as the total potential solution space defined as the product of the ranges of solution element 1 modify by applying the boundary condition created by the maximum range of solution element 1.
   5. Identify Set D₁ as the Intersection of Set A₁, Set B₁ and Set C₁. D₁=(A₁∩B₁∩C₁) . . . for clarity, that is to say that Set D is the set where all elements are a member of Set A and Set B and Set C simultaneously, as shown in the example in FIG. 22.
   6. Repeat Steps 1-5 for each solution element—e.g. D₂ (A₂∩B₂∩C₂); D₃=(A₃∩B₃∩C₃); D₄=etc. FIGS. 23A-23C illustrate examples of various intersecting sets.
   7. Assemble all bounded sets into a new Set E={D₁, D₂, D₃, . . . , Dₙ, etc.}, which is the set of bounded subsets.
   8. Enumeration of Potential Solution Space. In one embodiment of the system and method, define Set Z as the entire set of unique combinations or permutations created by the n-fold cartesian product of the ranges of solution elements in Set E, such that a solution graph of nodes is created for all combinations or permutations of all sets of solution elements. In another embodiment of the system and method, define Set Z as a subset of the entire set based on boundary conditions determined by the system. Let an individual node in Set Z be equal to the product of a unique combination of a single element from all Sets of D—creates an element of Set Z; e.g. Zₙ=D_{1, 1}·D_{2, 1}·D_{3, 1}· . . . ·D_{n, 1}·Zₙ ε D_{1, 1}·D_{2, 1}·D_{3, 1}· . . . ·D_{n, 1}. In the following example, let p,q, r represent solution numbers in the Set Z; and let n represent the nth set of D included in the Set E, and let w, j, k, m represent the W^{th}, J^{th}, K^{th} and M^{th} solution element in their respective Sets.:

Z₁=D_{1, 1}19 D_{2, 1}·D_{3, 1}· . . . ·D_{n, 1} a.

Z₂D_{1, 1}·D_{2, 1}·D_{3, 1}· . . . ·D_{n, 2} b.

Z₃D_{1, 1}·D_{2, 1}·D_{3, 1}· . . . ·D_{n, 3} c.

. . . d.

Zₚ=D_{1, 1}·D_{2, 1}·D_{3, 1}· . . . ·D_{n, m} e.

Z_{q}=D_{1, 1}·D_{2, 1}·D_{3, 1}· . . . ·D_{n, m} f.

. . . g.

Zᵣ=D_{1, w}·D_{2, j}·D_{3, k}· . . . ·D_{n, m} h.
9. In one embodiment of the system and method, this Set Z is the final result that is passed to the display for visualization and interaction by the user
iv. Computation of Solution Space. In another embodiment, the system and method may execute an algorithm or set of algorithms which may or may not be output sensitive algorithms based on the decision of an algorithm in the system, to compute one or more utility functions across each node (solution) in Set Z. Creating an additional step for the One example of a utility function that may be applied in certain use cases may include the computation of cost and benefits and metrics and corresponding public, private and derivative benchmarks for each item in Set Z, and the system and method may compute additional derivatives across the entire Set Z. In this embodiment of the system, the system creates Set Y.
v. In yet another embodiment of the system and method, the system may execute an algorithm or set of algorithms to apply one or more artificial intelligence algorithms to identify important features, and or clusters of nodes in the set of sets or individual nodes in any set—using one or more of a plurality of known algorithms in the field. These features may include discrete features on each node, features that are useful so the system may identify additional branch and bound criteria, features or observations that are useful to recommend most promising nodes to the user, etc. based on the discrete values of each item in Set Z and to the entire Set Z. This enables the system and method to identify one or more additional specific Branch and Bound conditions that may or may not be applied to one or more elements in Set Z to create the Subset X.
   1. In this embodiment, the system and method would compute adjustments to the ranges identified in the Enumeration of Potential Solution Space, based on derivative calculations based on the results included in Computation of Specific Solution Space.
   2. In this embodiment, the system would create Set X which is a Subset of Y, by dropping elements from Set X such that X ∩ Y or X ∩ Z or X ∩ Y ∩ Z to factor in additional boundary conditions.
vi. In one embodiment, to facilitate application of predictive analytics and visualization of the solution set, the system would calculate solution clusters using and algorithm or set of algorithms for all solutions in the Set (X, Y, or Z respectively). After element clusters have been computed, each element in the solution would be modified to include one or more solution cluster identification keys.
vii. Next, the system and method consolidates all remaining the branches and nodes into a consolidated graph of nodes. The system may or may not recursively apply additional algorithms to further refine the consolidated nodes, compute new nodes and/or new branches, compute additional data elements on one or more nodes, or refine clustering.
viii. Next, the system and method may execute an algorithm or set of algorithms to compress and encrypt the consolidated result and transfer to one or more local or remote locations for further processing through one or more of a plurality of methods, which may include direct in-memory transfer, file transfer, saving to a database, etc.
ix. Next, the system and method may execute an algorithm or set of algorithms to record log messages including process completion, system performance metrics, etc.

C. After final calculations are complete, the system and method may execute an algorithm or set of algorithms to automatically compute potential updates to benchmarks, complete supervised and/or unsupervised machine learning computations to refine benchmarks and/or create new derivative benchmarks, or apply computed updates based on system rules and/or system administrator decisions.

9. Embodiments of Solution Generation/Computation and Evaluation.

A. In one embodiment the system and method ingest a predefined set of possible applicants of students for admission to an educational institution, or allocation of financial aid to a set of students where the decision-making process is complex and multivariate, including factors directly observable in the initial data set, coupled with other benchmarks and probability based predictive analytics.

B. In another embodiment of the system and method, the system and method ingest a predefined set of possible solutions, and the execute an algorithm or set of algorithms to compute benchmarks, additional benchmark or evaluation criteria specified by the user, and may include probability based analysis to describe a multitude of possible future states based on the portfolio of inputs. One embodiment of this may include evaluation of a large portfolio of facilities repair and construction, or perhaps system development projects, where the allocation of investment is very complicated across a multivariate space including alignment with specific organizational groups, geographies, product lines; delivery phases of preceding projects; expected impact on other business results or systems, etc.

C. In another embodiment related to business operations improvement, the system and method computes the landscape of potential solutions associated with the result of each solution in the multitude of solutions that could exist for the user, plus the expected impacts on the business and its performance, and a set of performance metrics similar to the benchmarking analysis described earlier, all of which may or may not include probability based analysis such as Monte Carlo simulations.

10. Visualization of the Solution Space. The system and method then performs additional processing on the result set by executing an algorithm or set of algorithms to automatically to create, enable and provide a dynamic, interactive visualization or set of visualizations.

A. The user then interacts with the system and method interact through the computer to manipulate controls on the system to dynamically modify the visualization presented to them in real time. The objective of this activity is to visualize and understand the entire landscape of the multitude of enterprise solutions across multivariate dimensions, and to modify the display of the visualization based on the unpredictable multivariate manipulation of the controls by the user. The interactive visualizations may take a plurality of forms and combinations of forms, which may include but are not limited to a cross filter, a heatmap, a scatter map, parallel coordinates diagrams, veroni diagrams, or other illustrative methods, or a combination thereof.

B. The user continues to modify and explore the landscape of the multitude of solutions to understand and to identify one or more public or private values that may be either known or unknown to the user, and/or stated, or unstated to others, relating to one or more of the control dimensions. The user manipulates the controls of the visualization based on their perception of the displayed combination of individual and aggregate data and values (hereafter known as the “conditions”) on the visualizations, which may be either public or private, to modify the results displayed on the visualization to some subset of results that may meet all, some or none of the of the user's conditions. The results displayed on the visualization correspond directly to a specific set of conditions that yield a specific result or set of results (hereafter known as a “solution” or “solutions”).

11. Next the user interacts with yet another set of controls to save zero, one or more of the minimal set of solutions displayed in the visualization to a database.

12. The user then reviews one or more of the plurality of saved solutions in summary form on a text, table, or graphical summary displayed to the user by the system.

13. The user then selects one result or solution for further analysis by manipulating the computer controls.

14. The computer then dynamically generates a more detailed result/solution summary that includes a plurality of information that yielded this particular solution. This information includes a plurality of elements that may include the initial data provided by the user, public or private benchmarks used or displayed by the system in previous steps of this algorithm, initial/intermediate and final calculations performed by the system, and additional calculations and results that may be relevant to the decision process relating to this result.

15. In one embodiment, the computer then produces a performs risk analysis by building models of possible results by substituting a range of values for one or more elements on the node—a probability distribution—for all factors that have inherent uncertainty (e.g. probabilistic computation of likely decisions, or a Monte Carlo simulation of many independent variations of this solution). This enables the system and method to compute a quantitative range of potential results for each node and provides the decision-maker with a range of possible outcomes and the probabilities they will occur for this particular decision such that the user can consider the probability and impact of certain events occurring as an element of their decision process.

The candidate solution display may include interactive user interface such that the user can input addition data to require inclusion or exclusion or optionally change the relative prioritization of candidate solutions of the candidate set. In one embodiment, this may be done over multiple iterations by the user, or over multiple iterations with multiple users in collaboration.

16. The user may view the aforementioned detailed result online or download.

17. The user may then display the solution or share the downloaded detailed result with other key stakeholders in the decision-making process, if any.

18. The system and method then executes an algorithm or set of algorithms to automatically compute extensions, refinements and updates to public and private data, algorithms, values and derivatives thereof for future use.

19. Then, outside the system, the user plans, either alone or in concern with others, to implement or not implement the solution(s).

20. Then, outside the system, the user, either alone or in concern with others, implements the solution.

21. The user then, immediately, after some time, or periodically returns to the system and method described herein, to input updated data reflecting the then current state to repeat the process described herein for one or more elements of the decision space or portion thereof.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A system for manufacturing physical goods, comprising:
an input device configured to generate or receive input data, the input data describing parameters of one or more production facilities;
a computer processor configured to map the input data onto a graph, wherein each vertex of the graph comprises one or more solution elements, wherein the computer processor is further configured to apply one or more graph pruning algorithms to the graph, wherein the computer processer is further configured to determine one or more of the graph vertices as candidate solutions;
a display device configured to display a graphical representation of the candidate solutions, wherein the graphical representation includes a spatial representation of the candidate solutions organized by measurement criteria, wherein the graphical representation further includes an expansion interface that presents information specific to a selected one of the vertices of the graph; and
at least one production machine configured to received configuration parameters according to a selected one of the candidate solutions, wherein the configuration parameters are effective to control the operation of the production machine to manufacture a physical good.

2. The system of claim 1, wherein the computer processor is further configured to perform a clustering operation on the input data to generate at least one of the one or more solution elements.

3. The system of claim 2, wherein the clustering operation comprises one or more of a K-Nearest Neighbors algorithm, a K-Means algorithm, a Minkowski weighted k-means algorithm, a t-SNE algorithm, or a Principal Component Analysis algorithm.

4. The system of claim 1, wherein the one or more graph pruning algorithms comprise enumerative combinatorics, exponential generating functions, or output-sensitive computing algorithms, branch and bound algorithms, or Bloom filters.

5. The system of claim 1, wherein the input data corresponds to a manufacturing operation for a good comprising a plurality of components that are capable of being manufactured in a plurality of locations.

6. The system of claim 5, wherein the measurement criteria comprises machinery capable of producing at least one of the plurality of components, a cost of labor at each of the plurality of locations, a stockpile of supplies at each of the plurality of locations, and transportation distances between the plurality of locations.

7. The system of claim 5, wherein the candidate solutions comprise associations between each of the plurality of components and at least one of the plurality of locations.

8. The method of claim 7, wherein the computer processor is further configured to receive a single candidate solution selected from the candidate solutions and transmit instructions to a subset of the plurality of locations that correspond to the associations in the single candidate solution.

9. The method of claim 1, wherein the computer processor is further configured to receive a rejection of all the candidate solutions, wherein the input device is further configured to generate or receive additional input data, and wherein the computer processor is further configured to determine new candidate solutions based on the input data and the additional input data.
